(19) United States
(12) Patent Application Publication
(10) Pub. No.: US 2017/0206353 A1
(43) Pub. Date: Jul. 20, 2017

(54) METHOD AND SYSTEM FOR PREVENTING MALICIOUS ALTERATION OF DATA IN COMPUTER SYSTEM

(71) Applicant: Hope Bay Technologies, Inc., Taipei (TW)

(72) Inventors: BENCHIAO JAI, Taipei (TW); Chung-Hung Chiang, Taipei (TW); Jin-Shi Lee, Taipei (TW); Chi-Tung Tsai, Taipei (TW); Ching-Ting Liu, Taipei (TW); Yun-Hao Liang, Taipei (TW); Chun-Hung Lee, Taipei (TW)

(21) Appl. No.: 15/286,593

(22) Filed: Oct. 6, 2016

Related U.S. Application Data
(63) Continuation-in-part of application No. 15/001,176, filed on Jan. 19, 2016.

(51) Int. Cl. G06F 21/56; G06F 21/62; G06F 21/64

(52) U.S. Cl. CPC G06F 21/565; G06F 21/64; G06F 21/6218; G06F 2221/034

(57) ABSTRACT

The present disclosure includes a detection method for files infected by malware, especially ransomware, and an anti-malware system implemented with the method during file transmission, especially for backup or synchronization. Applying the detection method in the present disclosure before file transmission may prevent infection spreading by replace uninfected files with infected files. In one embodiment, the method includes: creating files as “baits” for being accessed by ransomware; and detecting whether files being to be transmitted due to updates including the “baits”. The present disclosure also includes file recovery method while finding malware infection by the detection method of in the present disclosure.

### CROSS-REFERENCE TO RELATED APPLICATIONS

The present application is a continuation-in-part application of: U.S. patent application Ser. No. 15/001,176, entitle “HYBRID CLOUD FILE SYSTEM AND CLOUD BASED STORAGE SYSTEM HAVING SUCH FILE SYSTEM THEREIN”, filed on Jan. 19, 2016, which is currently pending. The application is incorporated by reference herein their entirety.

### TECHNICAL FIELD

The present disclosure pertains to information security of cloud storage service, and more particularly for protecting data (e.g. files) from malicious alteration caused by malware, especially ransomware during backup and recovery (or synchronization) between client-side computing devices and cloud-based storage environment. In addition, at least one embodiment of the present disclosure pertains to protecting data from malicious alteration in a hybrid cloud file system of said cloud-based storage environment.

### BACKGROUND

Information security, especially protecting from computer virus, worm, Trojan or malicious software (malware) such as ransomware, is usually accomplished by scanning for detection and periodical backup for recovery from malicious data alteration. Conventional security software may keep scanning working procedures and files to be stored in the device for identifying malware and procedures of malware. While any data or procedure found to have relevance to malicious data alteration, the data or procedure will be deleted. For data maliciously altered by malware, conventional security software may periodically store a corresponding copy (or a snapshot of the whole system) as backup for recovery on user's demand once identifying malicious data alteration, such as file encryption/deletion caused by ransomware.

Conventionally, the scanning mechanism is accomplished by identifying patterns of malicious data alteration and maintaining a database of said patterns. Usually, patterns of malicious data alteration may be limited to its update frequency. The patterns of malicious data alteration corresponding to latest malware may not be identified and stored to the pattern database immediately. Therefore, the scanning mechanism usually performs poor for preventing from malicious alteration corresponding to latest malware, especially from ransomware which may be updated rapidly simply by replacing several details of file encryption therein.

As rapidly popular of cloud storage services, the backup and recovery thereof may also be one of the solutions to malicious data alteration. However, the aforementioned solution is limited of its scope by the storage resources required for storing copies. Beyond the scope, the data being maliciously altered may not be recovered. Moreover, in the scenario of multiple storage resources pooled together, files may be synchronized between the multiple storage resources causing malicious data alteration to be spread among the multiple storage resources through synchronization. In other words, once files in one of the storage resources being maliciously altered. Through synchronization, the files in the other storage resources may also be maliciously altered. For example, malicious alteration corresponding to ransomware may include file encryption and alteration of file name/file location. Ransomware usually charges users of a computer system for the password to decrypt the files or other solution to recovery from the malicious alteration. Conventional software with scanning mechanism and backup mechanism may not perform well due to said rapid emerging of ransomware and said limited scope in a single environment of backup and recovery.

A file management mechanism and system consolidated with security validation is provided for preventing data being maliciously altered by the aforementioned malware including computer virus, worm, Trojan and ransomware from being spread by backup or synchronization between different devices. The present disclosure may also provide embodiments of file recovery by replacing files corresponding to said malicious alteration with reserved copy or version which has not been maliciously altered in different devices. The present disclosure may also provide embodiments of aforementioned mechanism to a hybrid cloud file system integrating file management and synchronization between client devices and cloud-based storage environment.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an exemplary cloud storage system and a client device with file management system in accordance with some embodiments of the present disclosure.

FIG. 2 is a flow chart illustrating an exemplary validation and file transmitting process between said client device and said cloud-based storage system in accordance with some embodiments of the present disclosure.

FIGS. 3A and 3B are flow charts illustrating exemplary validation and file transmitting processes corresponding to said client device and said cloud-based storage system respectively in accordance with some embodiments of the present disclosure.

FIGS. 4A and 4B are flow charts illustrating exemplary validation processes by creating baits corresponding to said client device and said cloud-based storage system respectively in accordance with some embodiments of the present disclosure.

FIG. 5 is a schematic diagram illustrating an exemplary anti-malware (malicious software) system in accordance with some embodiments of the present disclosure.

FIG. 6 illustrates an exemplary cloud storage system and a client device each with the anti-malware system respectively in accordance with some embodiments of the present disclosure.

FIG. 7A illustrates an exemplary hybrid cloud storage system in accordance with some embodiments of the present disclosure.

FIG. 7B is a schematic diagram illustrating an exemplary operating system associated with a client device and a cloud storage cluster of cloud storage system.

FIG. 7C is a schematic diagram illustrating an exemplary operating system of the client device 100 in accordance with some embodiments of the illustration in FIG. 7B.

FIG. 7D is a schematic diagram illustrating exemplary network architecture of the cloud storage system in accordance with some embodiments of the present disclosure.

FIG. 7E is a schematic diagram illustrating an exemplary anti-malware system in accordance with some embodiments of the illustration in FIG. 7C.

FIG. 8 is a functional block diagram illustrating an exemplary electronic device in accordance with some embodiments of the illustrations in FIG. 6 to FIG. 7D.

### DETAILED DESCRIPTION

For consistency purpose and ease of understanding, like features are identified (although, in some instances, not shown) with like numerals in the exemplary figures. However, the features in different embodiments may differ in other respects, and thus shall not be narrowly confined to what is shown in the figures.

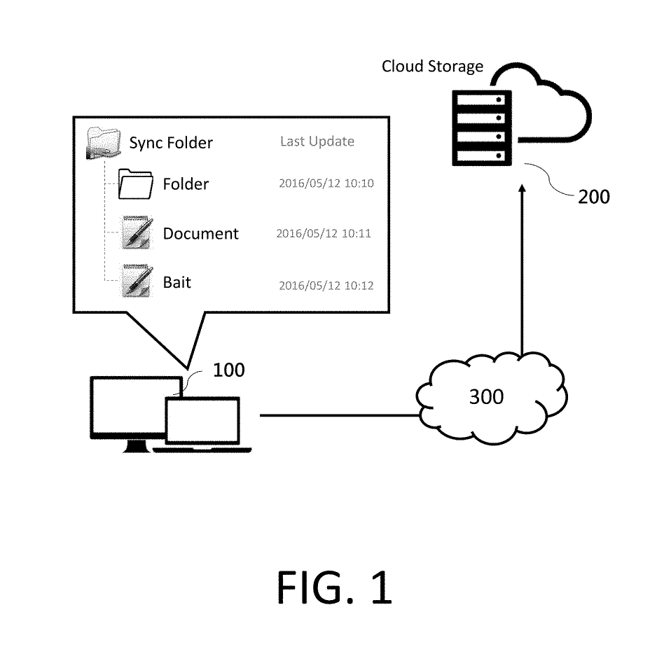

FIG. 1 illustrates an exemplary cloud storage system in accordance with some embodiments of the present disclosure. The exemplary cloud storage system may include a client device 100 capable of sending/receiving different type of files in a cloud storage server cluster 200 over a network 300. Referring to FIG. 1, the client device 100 may correspond to a file system having one or more folders for file storage and a folder depicted as “Sync Folder” for synchronizing files and directory of files (depicted as “Document” and “Folder” respectively in FIG. 1) to the cloud storage server cluster 200. A software procedure executed in the client device 100 may periodically check changes of files in the “Sync Folder” and transmitting the change information and/or files changed to the cloud storage server cluster 200 for the cloud storage server cluster 200 making corresponding file changes therein. In one embodiment of the present disclosures, dummy files without substantial contents may be created in the sync folder. These dummy files may contain metadata attracting malicious alteration from malware, especially ransomware. In aspect of the aforementioned reason, the dummy files are depicted as “bait” in FIG. 1 of the present disclosure. For example, a bait may have the same file extensions as documents and images such as “.txt”, “.csv”, “.jpg” . . . etc. In one embodiment of the present disclosure, the baits may be generated and mixed into a group of files stored in the same file folder in directory in the file system. In some implementations, the bait may have a file name, date of file following rules for being sorted and executed earlier than other files. On the other hand, the baits may have characteristics for not being accessed by users for preventing from mistaking user access of baits as malicious data alteration by malware. For example, the file name of the bait may apply rules for being identified as a dummy file by users such as “ab4687h”. While the bait is an image file, the indication as a dummy may be included in the image for file system presenting to the users for identification such as an image of a “this is a dummy file”. Validation of malicious data alteration especially data alteration by ransomware may be accomplished by monitoring data alteration corresponding to the baits. The users of computing systems are assumed not to access and edit the baits, and the data alteration of the baits may only be caused by malware without notification and permissions of the users. For detecting malicious data alteration in “every corner” of the storage, multiple and even large volumes of baits may be created systematically and stored in different file folders (data path in the file system) especially folders having a group of files. In one embodiment of the present disclosure, for detecting malicious data alteration by ransomware such as file encryption which changes files into another file type with only the same file name and a portion of file metadata, the identification may further be accomplished by monitoring files being newly generated and identifying ones with the same file name (or at least a portion of file metadata) as the baits from said newly created files. In some implementations, a database of the baits may be generated and maintained for comparing with data alterations in a computing system to monitor status of the baits and identify alteration of the baits. The monitoring of the baits may be accomplished by periodically scanning file folders including the baits. However, for saving system cost, the scanning may be replaced by monitoring of procedures or instructions to storage medium of the computing system. Instructions of data alternations such as file creation, file updates and file deletions may be captured and compared with the aforementioned database of the baits for identifying whether the data alterations correspond to the baits. Data alterations of the baits may play as a signal of malicious data alterations since alteration of the baits is assumed to be only caused by software especially what suspicious as malware.

The client device 100 may be a personal computer, a laptop computer, a personal data assistant, a cell phone, an automobile computer, a game console, a smart phone, or other computing devices capable of running software application and capable of accessing network. The network 300 may be any type of data network, including the Internet, a cellular network, a local area network, a wide area network, any other comparable network, or a combination thereof. Communication over the network may be conducted over a combination of wired and wireless arrangements. The cloud storage server cluster 200 may be one or more servers in any physical and virtual arrangement. In some implementations, the cloud storage server cluster 200 may be implemented in a single geographical location with each of the one or more servers communicably connected. In some implementations, the cloud storage server cluster 200 may be implemented in a distributed computing environment that utilizes several computer systems and components that are interconnected via wired/wireless communication links, using one or more computer networks or direct connections. In some implementations, the cloud storage server cluster 200 may be one or more virtual machines built on a software-defined resource pool provided by computing devices in multiple geographical locations. In some implementations, portions of the cloud storage server cluster 200 may selectively adopt the aforementioned physical and the virtual arrangements.

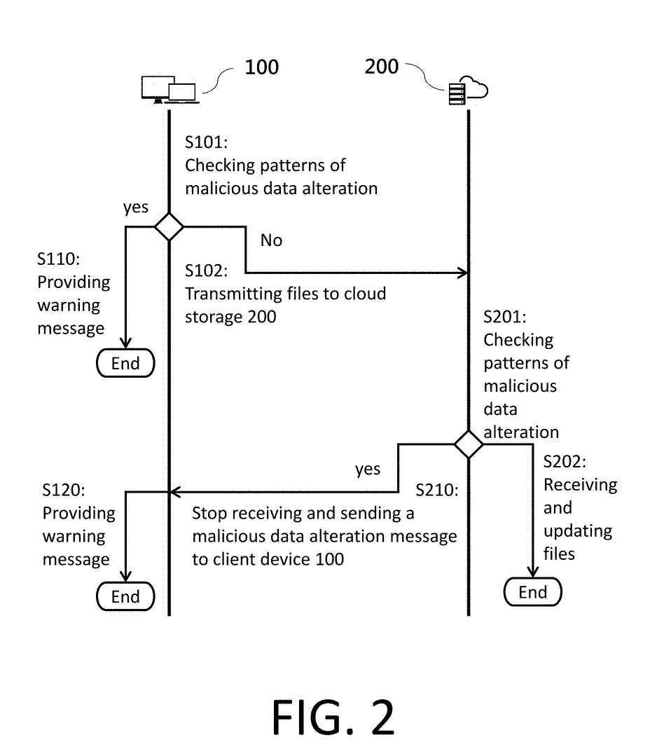

FIG. 2 illustrates an exemplary validation process of file transmission between the client device 100 and the cloud storage server cluster 200 in FIG. 1 in accordance with some embodiments of the present disclosure. Referring to FIG. 2, in step S101, the aforementioned software procedure executed in the client device 100 may Page 10 of 79 periodically check malicious alteration of data by recognizing corresponding patterns and determine whether data are maliciously altered (e.g. by malware), especially before transmitting (or synchronizing) files to the cloud storage server cluster 200. The patterns may include the aforementioned data alteration of baits and/or significant data alterations causing large volume of files to be synchronized in a short period. In one embodiment of the present disclosure, the pattern recognition may be conducted simultaneously with the periodical file synchronization. Before file synchronization starts in each period, the client device 100 may check file updates for both checking files to be synchronized (or backed-up) and pattern of malicious data alteration including file update frequency and data alteration corresponding to the baits. In step S110, if the client device 100 finds patterns of malicious data alterations, the client device 100 may halt or stop file synchronization, and in one embodiment of the present disclosure the client device 100 may provide a warning message of malicious data alteration to the user. In some implementations, the warning message may also be provided to the cloud storage server cluster 200. In one embodiment of the present disclosure, multiple detection means of the aforementioned patterns of malicious data alteration may be applied. The halting may start while finding patterns of malicious data alteration by a first detection mean, and the halting may last for only a period of time. During the period of time, the client device 100 may confirm malicious data alteration by applying other detection means to find other patterns of malicious data alteration. The client device 100 may stop file synchronization if malicious data alteration is confirmed through the aforementioned other detection means. On the other hand, the client device 100 may continue file synchronization if the aforementioned other patterns of malicious data alteration cannot be identified during the period of time (the halting time). For example, the client device 100 may halt file transmission for a period while finding frequent data alterations corresponding to a large scale of files. The client device 100 may further stop file transmission if any bait is found updated and requested to transfer. Otherwise, the client device 100 may further continue the file transmission after the aforementioned period. The aforementioned example may not limit the detection means in the present disclosure, for example, the client device 100 may also activate a procedure to monitor for any malware (especially ransomware) or instructions corresponding to data alterations of baits being executed therein for confirming malicious data alterations. In one embodiment of the present disclosure, the client device 100 may further provide the aforementioned warning message to anti-malware software installed and operated in the client device 100 for malware alert and corresponding file recovery. In one embodiment of the present disclosure, the client device 100 may further provide the aforementioned warning message and a scope of files corresponding to the malicious data alterations to the cloud storage server cluster 200 for receiving corresponding back-up files not being maliciously altered for file recovery. In step S102, if the client device 100 finds NO malicious data alteration, the client device 100 may start file synchronization by transmitting file update information and updated files to the cloud storage server cluster 200, and in some implementations, based on file updates check which may be conducted concurrently with the step S101. In step S201, in one embodiment of the present disclosure, the aforementioned software procedure may also be executed in the cloud storage server cluster 200 for checking patterns of malicious data alteration before the cloud storage server cluster 200 storing the received file updates and/or updated files to its corresponding location for file synchronization. The patterns may also include the aforementioned data alteration of baits and/or frequent data alteration corresponding to large a scale of files (to be stored for synchronization) in a period. In step S202, if the cloud storage server cluster 200 finds NO malicious data alteration, the cloud storage server cluster 200 may start file synchronization by storing received files and/or replacing files with the received files, and in one embodiment of the present disclosure, based on file updates check which may be conducted concurrently with the step S201. In step S210, if the cloud storage server cluster 200 finds malicious data alterations, the cloud storage server cluster 200 may halt or stop file synchronization by deleting the received files, and in one embodiment of the present disclosure the client device 100 may further provide a warning message of malicious data alteration to the client device 100. As mentioned previously, similarly, the halting may start while finding suspicion of malicious data alteration by a first detection mean and last for only a period. During the period, the cloud storage server cluster 200 may confirm malicious data alteration by other detection means. The cloud storage server cluster 200 may stop file synchronization if malicious data alteration is confirmed. On the other hand, the cloud storage server cluster 200 may continue file synchronization if malicious data alteration cannot be confirmed through the aforementioned other detection means. For example, the cloud storage server cluster 200 may halt file synchronization and just keep receiving file synchronization requests for a period while finding frequent data alterations corresponding to large scale of files in a period. The cloud storage server cluster 200 may stop file synchronization if any baits being altered and requested to synchronize. Otherwise, the cloud storage server cluster 200 may further continue the file transmission after the aforementioned period. In step S120, in one embodiment of the present disclosure, the client device 100 may also provide a warning message of malicious data alteration to the user of the client device 100 and/or anti-malware software installed and operated therein for malware deletion and/or file recovery.

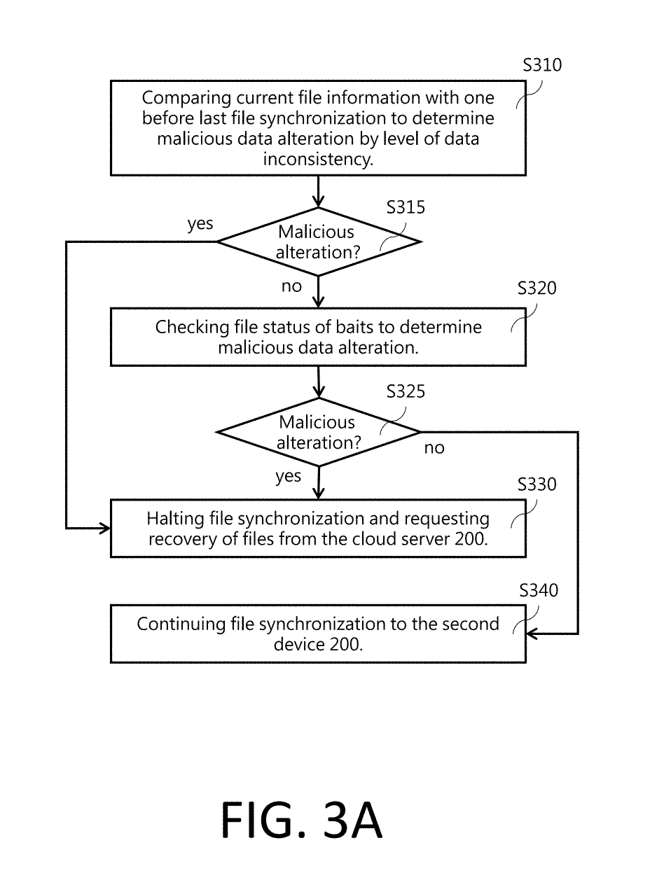

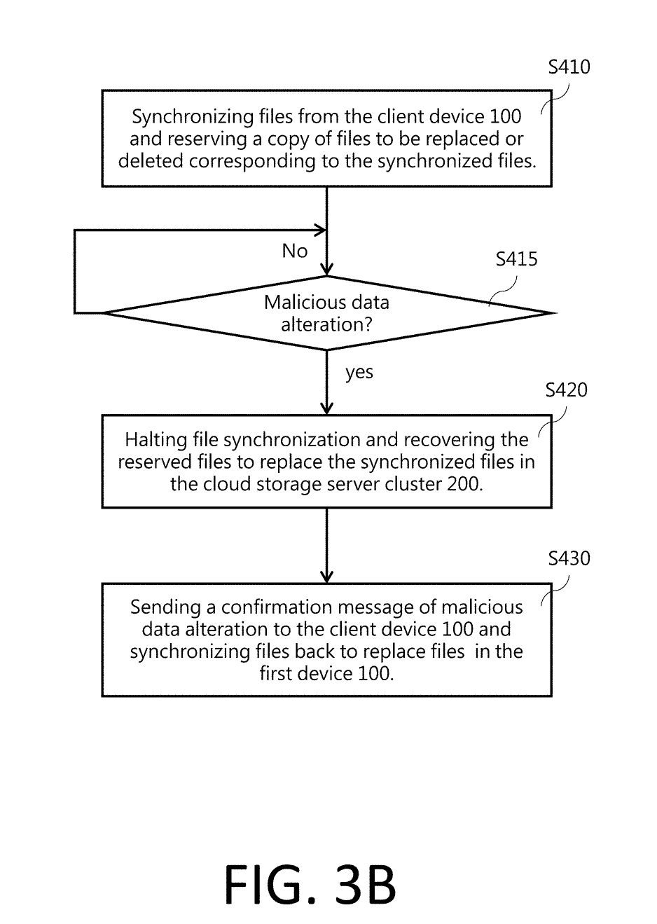

FIG. 3A illustrates an exemplary validation process of file transmission of the client device 100 in FIG. 1 in accordance with some embodiments of the present disclosure. Referring to FIG. 3A, in step S310, the aforementioned software procedure executed in the client device 100 may periodically comparing current file information with one before last file synchronization to determine malicious data alteration by level of data inconsistency, which determines also the scope of file synchronization to the cloud storage server cluster 200. In some implementations, the malicious data alteration may also be detected by checking frequency of data alteration instructions and corresponding scale of files. In step S320, the client device 100 may also check file status of baits to determine malicious data alterations. In one embodiment of the present disclosure, the checking may be accomplished simply by identifying the aforementioned baits in updated file list to be transferred to the cloud storage server cluster 200. In one embodiment of the present disclosure, if the client device 100 finds malicious data alteration, in step S330, the client device 100 may halt file synchronization procedure and stop transferring files to the cloud storage server cluster 200. The client device 100 may further request for back-up files from the cloud storage server cluster 200 to replace the malicious altered files for file recovery. The scope of file for recovery may be determined by scanning to identify the maliciously altered files or simply all files updated in a specific time period based on the time that malicious data alteration is identified. In one embodiment of the present disclosure, if the client device 100 finds NO malicious data alteration, in step S340, the client device 100 may continue transferring files to the cloud storage server cluster 200. The present disclosure may NOT be limited to the order of steps 5310 and 5320, and between steps 5310 and 5320, there may be a step S315 for directing to the next of the steps 5310 and 5320 if malicious data alteration is NOT found and to step S330 upon finding malicious alteration of data. Similarly, there may be a step S325 for directing from the next of the steps 5310 and 5320 to the step S340 if malicious data alteration is NOT found and to step S330 upon finding malicious data alteration. In one embodiment of the present disclosure, the halting may start while finding suspicion of malicious data alteration by a first detection mean and last for only a period. The checking of malicious data alteration by step S310 and Step S320 may be performed iteratively during the halting. For example, while finding malicious data alteration, the client device 100 may halt the file synchronization procedure for a period for confirming malicious data alteration through the other step. Once confirming malicious data alteration, the client device 100 may stop file synchronization and request file recovery; otherwise, the client device 100 may continue file synchronization in step S340.

FIG. 3B illustrates an exemplary validation process of file receiving and storing of the cloud storage server cluster 200 in FIG. 1 in accordance with some embodiments of the present disclosure. Referring to FIG. 3B, in step S410, the cloud storage server cluster 200 may periodically receive files/file updates from the client device 100 and maintaining/updating corresponding copies of the received files for file synchronization with the client device 100. The cloud storage server cluster 200 may further reserve copies of files to be replaced or deleted corresponding to which are updated or deleted in the client device 100 (the synchronized files). In one embodiment of the present disclosure, in step S415, the aforementioned software procedure may also be executed in the cloud storage server cluster 200 and periodically check whether files/file updates to be synchronized in a specific period (denoted as “file update frequency”) meet a threshold for determining malicious data alteration by level of data inconsistency. If the aforementioned file update frequency does not meet the threshold, implying no malicious data alteration, the software procedure may keep monitoring the file update frequency. In another embodiment of the present disclosure, malicious data alteration may also be determined by checking whether file updates received (corresponding to files updated in the client device 100) include baits generated in the client device 100. Once the aforementioned baits found updated, the cloud storage server cluster 200 may determine file updates received adjacent to the baits as being suspicious of being maliciously altered. The scope of file recovery may be therefore determined. In one embodiment of the present disclosure, if the file update frequency threshold is met, indicating occurrence of malicious data alteration, in step S420, the cloud storage server cluster 200 may halt the file synchronization to prevent maliciously altered files from spreading among devices. In one embodiment of the present disclosure, the cloud storage server cluster 200 may further determine files having suspicion of being maliciously altered (by malware) and retrieve corresponding reserved copies to replace the aforementioned maliciously altered files for file recovery. In one embodiment of the present disclosure, the cloud storage server cluster 200 may send a confirmation message of malicious data alteration to the client device 100 for initiating anti-malware procedures including malware deletion and/or file recovery in the client device 100. In one embodiment of the present disclosure, the client device 100 may further request for file recovery from the cloud storage server cluster 200, and the cloud storage server cluster 200 may also send the aforementioned reserved copies back to the client device 100 as synchronizing back to replace the files suspicious of being maliciously altered by the reserved copies. The aforementioned file recovery may also be initiated by the users of the client device 100 (and/or the cloud storage server cluster 200) after the client device 100 (and/or the cloud storage server cluster 200) providing the warning messages to the user. In one embodiment of the present disclosure, the halting may start while finding suspicion of malicious data alteration by a first detection mean and last for only a period of time. While finding malicious data alteration, the cloud storage server cluster 200 may halt the file synchronization procedure for a period for confirmation through the other means, for instance, waiting to receive a warning message of malicious data alteration from the client device 100 triggered by data alteration of the aforementioned baits stored therein. Once confirming malicious data alteration, the cloud storage server cluster 200 may stop file synchronization and synchronize files back to the client device 100; otherwise, the cloud storage server cluster 200 may continue file synchronization in step S410.

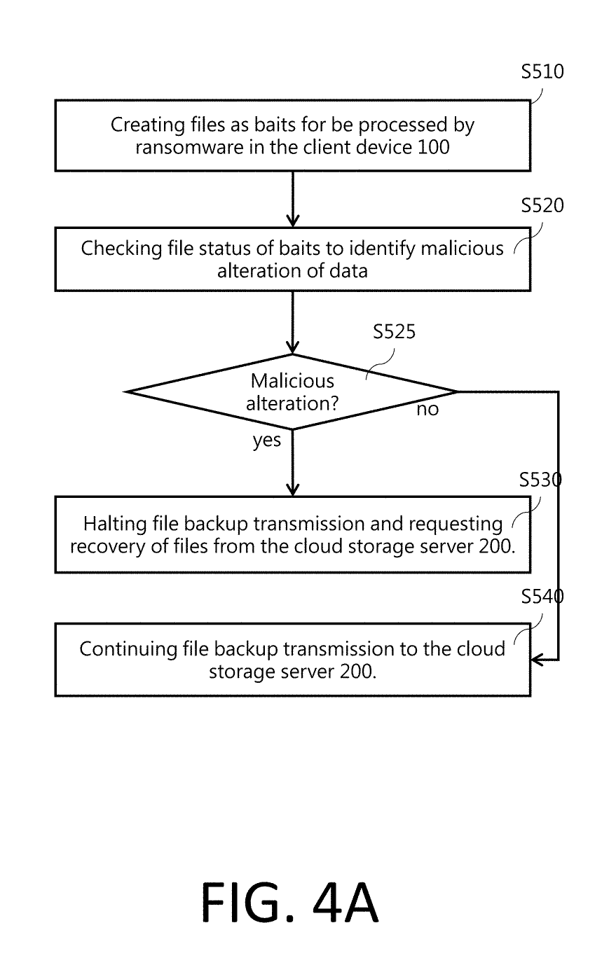

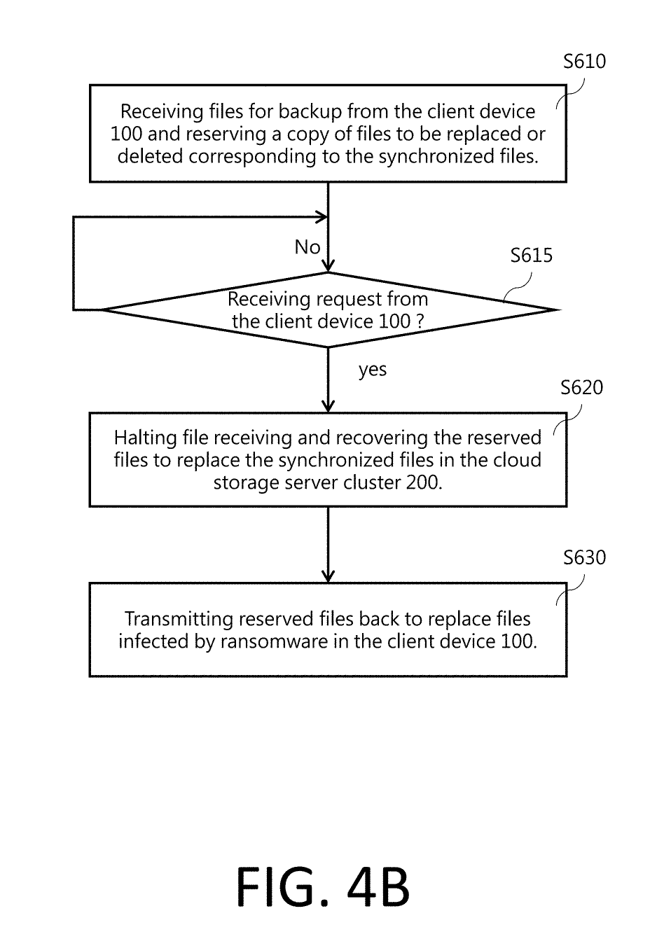

FIG. 4A illustrates an exemplary validation process of file transmission of the client device 100 in FIG. 1 in accordance with some embodiments of the present disclosure. Referring to FIG. 4A, in step S510, the client device 100 may create files as the aforementioned baits and store the baits into file folders as an indicator of malicious data alteration by ransomware, and even an indicator having higher priority to be processed by ransomware (or other types of malware). In one embodiment of the present disclosure, the bait may be generated and mixed into a group of files and child file folders in a parent file folder for being identified equally as other files in the group by ransomware. In one embodiment of the present disclosure, the bait may have characteristics to be scheduled in higher priority for ransomware processing, such as file name for being sorted first in alphabetic order, date of file update for being sorted first in time-descending order and file extension for being recognized as user generated contents. In one embodiment of present disclosure, the bait may also have characteristics for being recognized as bait to avoid accidental access/change by users such as file name for being recognized as meaningless and content for being recognized as “bait”. For example, the client device 100 may create images including the words “this is a bait” therein for being recognized while the file system access the image and providing a preview for avoiding users to change the file. In step S520, the client device 100 may periodically check file status of baits to identify malicious alteration of data by ransomware. In one embodiment of the present disclosure, the client device 100 may transmit updated files to the cloud storage server cluster 200 for backup. The client device 100 may check whether the updates of files including the baits for identifying malicious alteration of data by ransomware since the baits are assumed not being changed by users and assumed being changed only by encryption and/or deletion of ransomware. In one embodiment of the present disclosure, the client device 100 may further check whether the updates of files including files with the same file name or at least a portion of file metadata as the baits for identifying malicious encryption by ransomware which generally causes files to be encrypted into another file type with only the same file name and a portion of file metadata. While the data of baits being altered, it may imply files in the same folder and/or in the adjacent folders where the baits located also being maliciously altered (e.g. encrypted or deleted) by ransomware. In one embodiment of the present disclosure, in step S525, upon detecting malicious alteration of data by ransomware, the client device 100 may halt file transmission (or file backup) for preventing the malicious alteration of data spread to the cloud storage server cluster 200 through replacing files in the cloud storage server cluster 200 with maliciously altered files from the client device 100 in step S530. In one embodiment of the present disclosure, the client device 100 may also activate a procedure to monitor for instructions corresponding to data alterations of baits being executed therein for confirming malicious data alterations. In one embodiment of the present disclosure, the halting may start while finding suspicion of malicious data alteration by identifying an altered bait and may last for only a period. During the period, the client device 100 may check whether a second or more baits being altered to confirm malicious alteration of data by ransomware which usually maliciously alters a large scale of files. If no other baits altered in the period, the client device 100 may continue the file backup transmission due to no confirmation of malicious data alteration. In one embodiment of the present disclosure, also in step S530, the client device 100 may further request recovery of maliciously altered files (e.g. files encrypted by ransomware) from the cloud storage server cluster 200. The client device 100 may determine scope of files suspicious of being maliciously altered and request for recovery. The client device 100 may further receive corresponding files from the cloud storage server cluster 200 and replace the files suspicious of being maliciously altered with the received files. In one embodiment of the present disclosure, the client device 100 may provide messages for guidance and user interface for confirmation in each step of the aforementioned file recovery. If malicious alteration of data by ransomware is not detected in step S525, in step S540, the client device 100 may continue transmitting files to the cloud storage server cluster 200 for file backups.

FIG. 4B illustrates an exemplary validation process of file transmission of the cloud storage server cluster 200 in FIG.1 in accordance with some embodiments of the present disclosure. Referring to FIG. 4B, in step S610, the cloud storage server cluster 200 may receive files from the client device 100 for backup. The cloud storage server cluster 200 may also reserve copies of files to be replaced or deleted corresponding to which are updated or deleted in the client device 100. In one embodiment of the present disclosure, while not receiving request from the client device 100, the cloud storage server cluster 200 may continue receiving files for updates (repeating step S610). In one embodiment of the present disclosure, if the cloud storage server cluster 200 receives file recovery request from the client device 100 (in accordance with step S530 in FIG. 4A), indicating files in the client device 100 being maliciously altered by ransomware, the cloud storage server cluster 200 may halt file receiving, retrieve the aforementioned reserved copies corresponding to the file recovery request from the client device 100 and replace the synchronized files suspicious of being maliciously altered in the cloud storage server cluster 200. In one embodiment of the present disclosure, the aforementioned files suspicious of being maliciously altered may be determined by the client device 100 and transmitted to the cloud storage server cluster 200. In another embodiment of the present disclosure, the aforementioned files suspicious of being maliciously altered may be determined by the cloud storage server cluster 200 which determines a scope of folders (locations of files) and scope of transmitting time adjacent to the file recovery request from the client device 100 as the scope of files suspicious of being maliciously altered. In one embodiment of the present disclosure, in step S630, the cloud storage server cluster 200 may further transmit the aforementioned reserved files back for replacing files (suspicious of) being maliciously altered by ransomware in the client device 100.

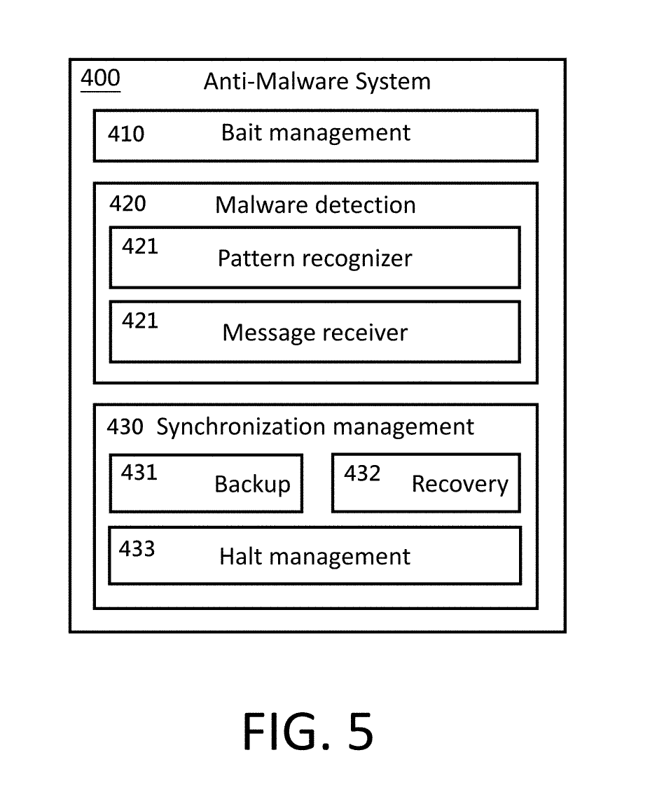

FIG. 5 illustrates an exemplary anti-malware (or anti-ransomware specifically) system implemented within the client device 100 and/or the cloud storage server cluster 200 in accordance with some embodiments of the present disclosure. In one embodiment of the present disclosure, in the client device 100, the exemplary anti-malware system 400 may be provided capable for managing file synchronization to the cloud storage server cluster 200, detecting malicious data alteration and managing baits as a support for malicious data alteration. The anti-malware system 400 may include a bait management module 410 for creating baits in the client device 100, a malware detection module 420 for detecting malware infection and a synchronization management module 430 for halting backup process and requesting for file recovery upon finding malware infection. In one embodiment of the present disclosure, the bait management module 410 may create baits as an indicator of malicious data alteration by malware (or ransomware specifically) and maintain a list of baits for determination of malicious data alteration by the malware detection module 420 comparing altered files or data alteration instructions with the list. The malware detection module 420 may include a pattern recognizer 421 for maintaining a list of patterns of malicious data alterations such as the aforementioned data alteration frequency (or data inconsistency between both sides of synchronization) and alteration of baits. For example, in one embodiment of the present disclosure, the pattern recognizer 421 may check file updates (or instructions corresponding to file updates) to find if there are any baits updated indicating occurrence of malicious data alteration in the computing system implemented with the anti-malware system 400. The malware detection module 420 may also include a message receiver 421 for receiving messages of malicious data alteration from other devices such as the cloud storage server cluster 200. For example, in accordance of the step S430 in FIG. 3B, the cloud storage server cluster 200 may send a message of malicious data alteration to the client device 100 upon recognizing patterns of malicious data alteration such as high update frequency or data alteration of baits in files received from the client device 100. The anti-malware system 400 in the client device 100 may be acknowledge of malicious data alteration from the aforementioned message sent from the cloud storage server cluster 200. In one embodiment of the present disclosure, the synchronization management module 430 may include a backup management component 431 for managing file transmission to the cloud storage server cluster 200 especially for maintaining file updates as one of data sets for the pattern recognizer 421 determining malicious data alteration, a halt management component 433 for halting file transmissions (especially for file backup) while the pattern recognizer 421 identifying malicious data alteration, and a recovery management component 432 for requesting file recovery from the cloud storage server cluster 200 and replacing maliciously altered files with corresponding ones received from the cloud storage server cluster 200 in accordance with the embodiments of the previous paragraphs.

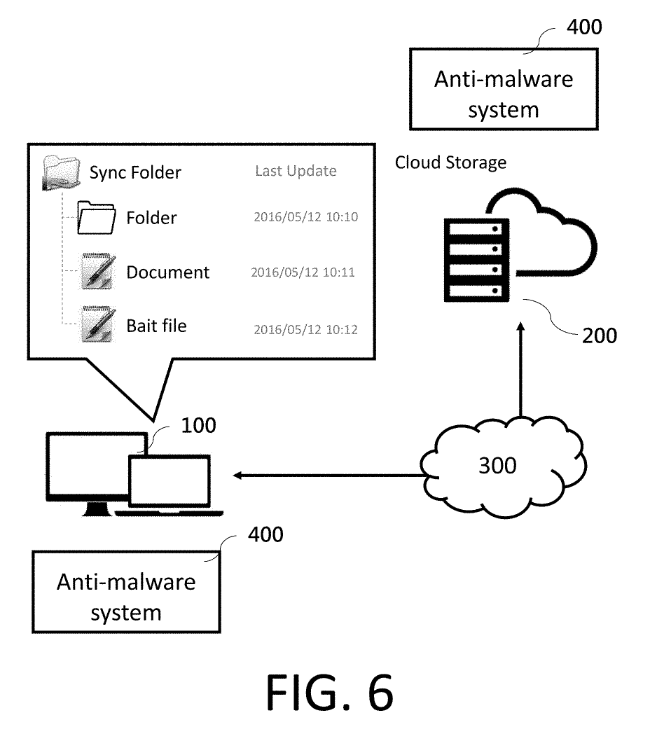

FIG. 6 illustrates an exemplary anti-malware (or anti-ransomware specifically) system implemented within both the client device 100 and the cloud storage server cluster 200 in accordance with some embodiments of the present disclosure. In one embodiment of the present disclosure, the in the cloud storage server cluster 200, the exemplary anti-malware system 400 may be provided capable for managing file synchronization from the client device 100 and detection malicious alteration of data in the client device 100. The bait management module 410 in the exemplary anti-malware system within the cloud storage server cluster 200 may also maintain the aforementioned list of baits generated in the client device 100 and received from the client device 100 in one embodiment of the present disclosure. The pattern recognizer 421 of the malware detection module 420 may identify malicious data alteration from files received from the client device 100 by various detection means including mapping file updates in the client device 100 to the list of baits or monitoring file update frequency in accordance with embodiments in the previous paragraphs. The message receiver 422 of the malware detection module 420 may receive file recovery request from the client device 100 implying malicious data alteration in the client device 100 in one embodiment of the present disclosure. The backup management component 431 of the file synchronization module 430 may also manage file receiving from the client device 100 which may further be one of data sets for the pattern recognizer 421 determining malicious data alterations in the aforementioned files from the client device 100. The halt management component 433 of the file synchronization module 430 may also halt file receiving while the pattern recognizer 421 finding malicious data alteration. The recovery management component 432 of the file synchronization module 430 may reserve copies of files to be deleted and update corresponding to the file updates received from the client device 100. The recovery management component 432 may further retrieve files from the copies according to file recovery request received from the client device 100 and replace files (suspicious of) being maliciously altered in the cloud storage server cluster 200 with the retrieved copies according to the file recovery request. In some implementations, the recovery management component 432 may transmit the retrieved copies to the client device 100 as a response to the file recovery request for replacing the files (suspicious of) being maliciously altered in the client device 100. Referring to FIG. 6 again, the anti-malware system may be both implemented in the client device 100 and the cloud storage server cluster 200 for managing synchronization and detecting malicious data alteration in accordance of embodiments illustrated in previous paragraphs. Therefore, the anti-malware system 400 may NOT limit to be implemented in specific types of devices. Devices including files to be backed up or device for receiving file for backup may implement with the exemplary anti-malware system 400 in accordance with some embodiments of the present disclosure.

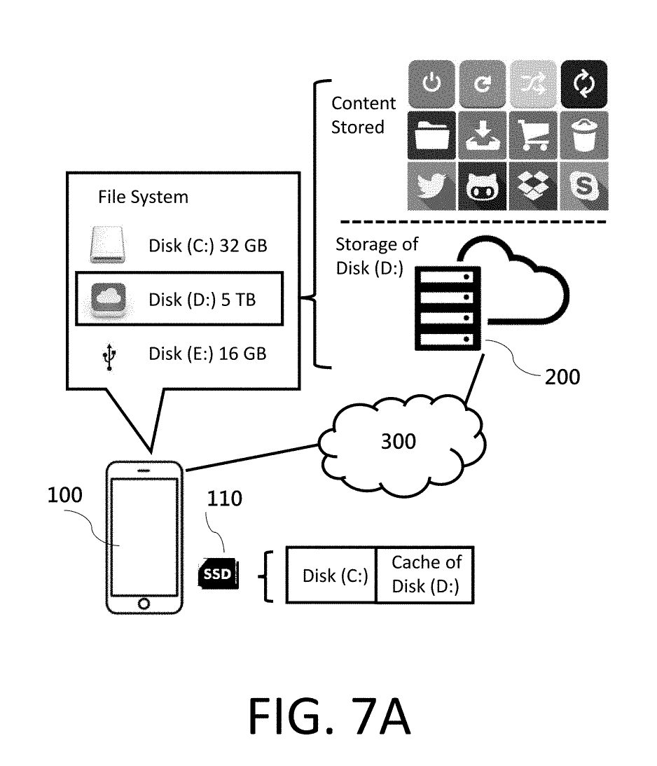

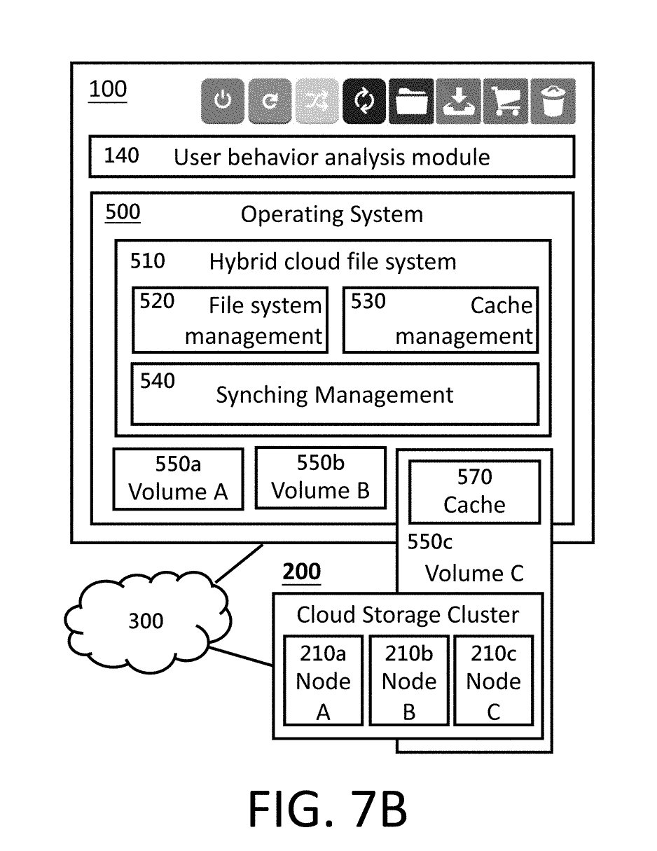

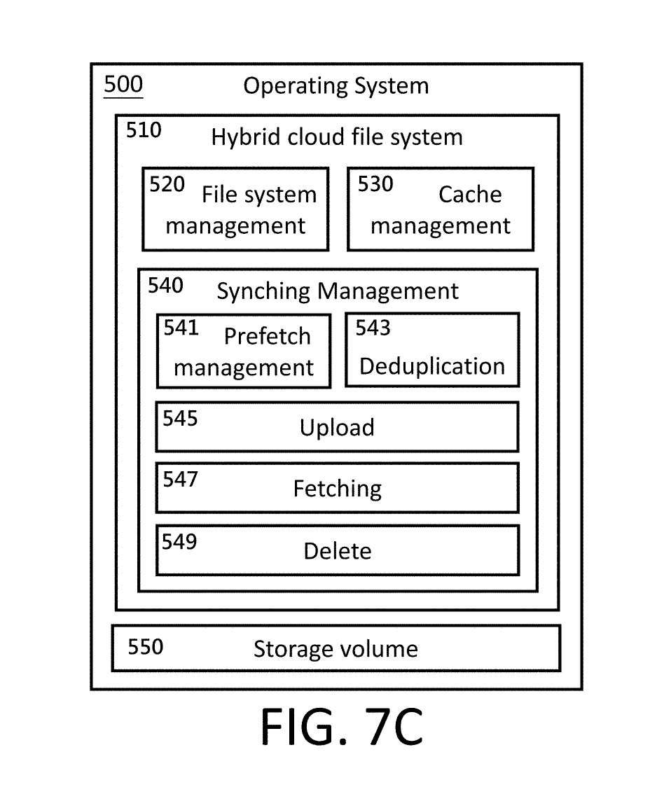

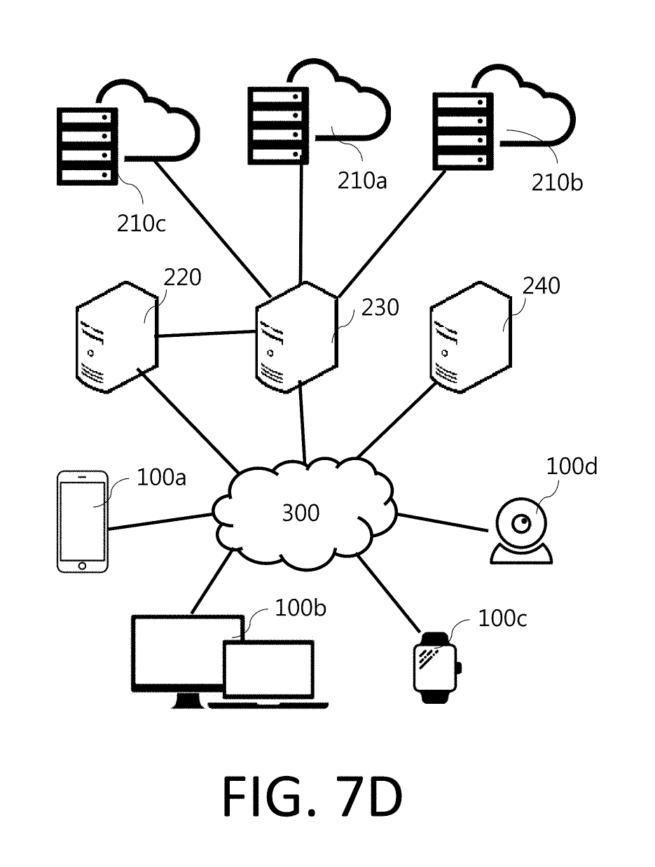

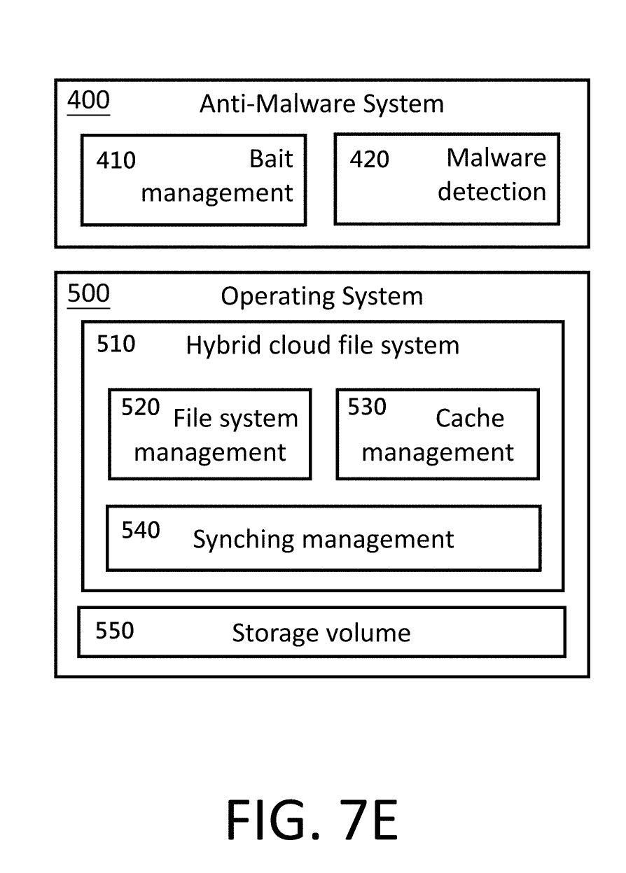

FIGS. 7A to 7E illustrate the anti-malware system 400 in a hybrid cloud file system in accordance with embodiments of the present disclosure. Referring to FIG. 7A, the client device 100 may correspond to a file system having one or more storage volumes depicted as “Disk (C:)”, “Disk (D:)” and “Disk (E:)” in FIG. 7A. Each volume may correspond to different storage medium. For example, the client device 100 may comprise a local storage medium 110 presented as the “SSD” icon with its storage arrangement presented in the right of the icon in FIG. 7A. Portion of the local storage medium 110 may be allocated for the storage volume “Disk (C:)” having a size of 32 Giga Bytes. The storage volume “Disk (E:)” may correspond to an external storage medium such as a computer peripheral storage device with a USB (Universal Serial Bus) port. The storage volume “Disk (D:)” having significantly larger size may correspond to a storage volume allocated for the client device 100 in the cloud storage server cluster 200. Contents stored in the allocated storage volume in the cloud storage server cluster 200 may be presented as stored in the storage volume “Disk (D:)” in the operating system of the client device 100. Manual operations of data storing and accessing to a file in the storage volume “Disk (D:)” may have no difference with a file in the storage volume “Disk (C:)” and “Disk (E:)”. Therefore, a user of the client device 100 may not even notice that the physical location of the content stored in the storage volume “Disk (D:)”. In addition, the size of the storage volume “Disk (D:)” may be flexibly arranged by adjusting allocated storage volume in the cloud storage server cluster 200 in the state of art of cloud computing technology and cloud storage service model. The cloud storage system in accordance with the instant disclosure may enable user experience of a significantly larger storage volume in the client device 100 than its onboard components physically provided therein. In some embodiments, a portion of the local storage medium 110 may be allocated as a cache volume for the storage volume “Disk (D:).” In such instances, a portion of data contents stored in the cloud storage server cluster 200 may be copied and stored in the cache volume to accelerate data accessing. The client device 110, as well as the cloud storage server cluster 200, may typically include an operating system that provides executable program instructions for the general administration and operation of that device (e.g. the client device 100, servers of the cloud storage server cluster 200). In addition, the local storage medium 110 may be non-transitory computer-readable media storing instructions that, when executed by a processor of the device, allow the device to perform its intended functions. Suitable operating system for each of the devices may differ depending on the type and nature of the device. For instance, the client device 100 may be a personal computer running on a commercially available Windows™ operating system; the client device 100 may also be a cellular phone running on an Android operating system; while the cloud storage server cluster 200 may be operating on a Linux based operating system. Suitable implementations for the operating system and general functionality of the servers may be known or commercially available and are readily implemented by persons having ordinary skill in the art, particularly in light of the disclosure herein.

FIG. 7B illustrates an exemplary operating system associated with the client device 100 and a cloud storage cluster 200 of cloud storage system in accordance with some embodiment of the present disclosure. In the client device 100, an exemplary operating system 500 may be provided capable for managing the hardware resources of the client device 100 and providing services for running applications (e.g., mobile applications running on mobile devices). In some implementations, the operating system 400 and the application software may be stored in a local storage medium of the client device 100 such as the local storage medium 110. In some implementations, the operating system 500 may also be stored in the cloud storage server cluster 200 providing for download into the client device 100 and executed by the client device 100 at stage of booting up. The application software may also be stored in the cloud storage server cluster 200 providing for download after booting up. In some implementations, the applications stored in the client device 100 may include applications for general productivity and information retrieval, including email, calendar, contacts, and weather information, or include applications in other categories, such as gaming, GPS and other location-based services, banking, order-tracking, ticket purchases or any other categories as contemplated by a person having ordinary skill in the art. In some implementations, the applications stored in the client device 100 may provide functions related to operating system 500. For example, a user behavior analysis module 140 for collecting data access patterns of data access operations performed by the operating system 400 and sending to the cloud storage server cluster 200 for various analyses. The cloud storage server cluster 200 may include one or more storage nodes 210a, 210b and 210c. Each of the storage nodes 210 may contain one or more processors and storage devices. The storage devices may include optical disk storage, RAM, ROM, EEPROM, flash memory, phase change memory, magnetic cassettes, magnetic tapes, magnetic disk storage or any other computer storage medium that can be used to store data content.

Referring to FIG. 7B again, the exemplary operating system 500 of the client device 100 may be provided including a hybrid cloud file system 510 and one or more storage volumes depicted as 550a, 550b and 550c. The storage volume 550c may be defined and provided by an authorized storage volume in the cloud storage server cluster 200 via the network 300. In some implementations, a cache storage 570 may be allocated corresponding to the local storage medium 110. In some implementations, as depicted in FIG. 2, the cache storage 570 may be a data storage space virtually defined in the storage volume 550 which corresponds to the local storage medium 110. In some implementations, other than what depicted in FIG. 7B, the cache storage 570 may also be an independent data storage space virtually defined and corresponding to the storage volume 550. The cache storage 570 may be defined to provide the hybrid cloud file system and the storage volume 550 a buffering region that is similar in concept to the page file in a memory management system. The data contents stored in the storage volume 550c may be uploaded to the cloud storage server cluster 200, and a copy of data contents may be stored in the cache storage 570 for accelerating access by directly access the copy in the cache storage 570. Space of cache storage 570 is far limited comparing to the storage volume in the cloud storage server cluster 200. Therefore, a space releasing mechanism may be applied. That is, data contents in the cache storage may be allowed to be overwritten and replaced by other data contents. In some implementations, a storage locking mechanism may be provided in the cache storage 570. That is, locked data may be kept and not overwritten in the cache storage 570 while unlocked data not kept and allowed to be overwritten. Data contents in the cache storage 570 may be assigned to be locked for accelerating access. Usually, a verb “pin” may be used for describing the operation of locking. A pinned data content may always be kept in cache storage 570 for accelerating access and not be allowed to be overwritten. Similarly, another term “unpin” may be used for describing the operation of unlocking. A pinned data content may be unpinned to release the space by allowing to be overwritten. In some embodiments, the cache storage 570 may be shared by multiple storage volumes. For example, a shared cache storage 570 may be defined and assigned to the storage volumes 550a, 550b and 550c. Data contents in the storage volumes 550a, 550b and 550c may be allowed to be temporarily stored in the cache storage 570 to accelerate data accessing. The aforementioned “pin”/“unpin” mechanism may also be applied in the cache storage 570. In some implementations, a space in the local storage medium 110 may be allocated for the cache storage 570. Similarly, in some implementations, spaces in multiple local storage media including the local storage medium 110 may also be allocated for the cache storage 570. In some embodiments, when more than one cloud storage volumes are created for the client device 100 (the physical storage capacity of which correspond to storage volume in the cloud), the single local cache storage 570 may also be assigned for the plurality of newly created cloud storage volumes.

The hybrid cloud file system 510 may comprise a file system management module 520 for managing data contents in the storage volumes 550 and a synching management module 540 for managing data synchronization between the client device 100 and the cloud storage server cluster 200. The file system management module 520 may receive commands for data manipulations from the user interface and update the directory information accordingly. The synchronization management module 540 may manipulate the data stored in the cloud storage server cluster 200 according to the commands including data storing, data fetching, data updating and data deleting. The synchronization management module 540 may generate data manipulation request according to the commands and send to the cloud storage server cluster 200 for performing accordingly. In some implementations, applications may read data from or write data to the files as if the files are stored in the storage volumes 550. The file system management module 520 may receive read/write requests during the performance of the applications, and the synching management module 530 may retrieve the content data of the file from the cloud server 250 to satisfy the read or write requests. For example, the file management module 520 may receive a command for processing a file from a specific location in the storage volume 550c. The synchronization management module 540 may send a request for downloading the file and receiving the file from the cloud storage server cluster 200 for data processing. If any update occurs during data processing, the file management module 520 may further receive a command for storing the updated file into a specific destination (or data path) in the storage volume 550c. The synchronization management module 540 may further send an uploading request with the file to the cloud storage server cluster 200 for storing in the allocated storage volume in the cloud storage server cluster 200. The file management module 520 may further record the data storing into the destination and updating directory information corresponding to the storage volume 550c accordingly.

In some embodiments, a cache management module 530 for managing data contents in the cache storage 570 may also be included in the hybrid cloud file system 510. The file system management module 520 may receive commands for data manipulations from the user interface and update the directory information accordingly. The cache management may fetch/store the data in the cache storage 570 for accelerating data access or as a local buffer before the data uploading to the cloud storage server cluster. For example, the file management module 520 may receive a command for processing a file from a specific location in the storage volume 550c. The cache management module 530 may allocate a space in the cache storage 570 for the file and the synchronization management module 540 may obtain the file from the cloud storage server cluster 200. If any update occurs during data processing, the cache management module 530 may update the file in the cache storage 570. The synchronization management module 540 may further send an uploading request with the file to the cloud storage server cluster 200, and the file management module 520 may further update directory information accordingly. In some implementations, the cache management 530 may further configure data contents to be pinned/unpinned for space management. The cache management 530 may only release the storage of unpinned data contents in the cache storage 570 by allowing the unpinned data contents to be overwritten.

FIG. 7C further illustrates the exemplary operating system in FIG. 7B in accordance with some embodiment of the present disclosure. The synching management module 540 may further comprise a prefetch management component 541 for determining a prefetching plan to fetch data contents before being initiated by a user, a deduplication component 543 for checking duplicated data contents for data compression, an upload management component 545 for uploading data contents to the cloud storage server cluster 200 according to an uploading policy, a fetching management component 547 for downloading requested data contents from the cloud storage server cluster 200 according to user command or the prefetching plan and a delete management component 549 for deleting data contents from the local storage medium 110 and the cloud storage server cluster 200.

Referring to FIG. 7C, the prefetch management component 541 may determine a prefetching plan identifying particular data contents having a high probability to be accessed by the applications. A prefetching operation in accordance with some embodiments of the present disclosure is to download data files from the cloud storage server cluster 200 before being initiated by user actions. Because in a cloud storage environment, the data content of a file is typically stored in the cloud storage server cluster 200, the file access may take a longer time. To alleviate this situation, the prefetch management component 541 of the client device 100 may possess the ability to identify the data content of a file that are likely to be accessed by the user, and may accordingly prefetch the data content and store them in locally defined cache storage 570 in the client device 100. The prefetching plans may be used to identify the storage objects that are likely to be used based on a usage pattern of the storage objects. Moreover, different prefetching plans may be generated for multiple devices associated with the same or different user. The cache management module 530 may further initiate caching certain data contents into the local storage medium 110 according to the prefetching plan. In some embodiments, metadata of the electronic files (e.g. descriptions, parameters, priority, date, time, and other pertinent information regarding data content.) may be stored in the storage volume 550, while the content of the files may be stored in the cloud storage server cluster 200. The file system management module 520 may present the files to the applications and users of the client device as if the content data are stored locally. On the other hand, the prefetch management component 541 may be responsible for retrieving content data from the cloud storage server cluster 200 as cache data to accelerate data access based on the metadata, access pattern and other factors of the data contents. In some implementations, the user behavior analysis module 140 in FIG. 7B may collect the aforementioned access pattern for the prefetch management component 541 to determine and update the prefetching plan accordingly.

Referring to FIG. 7C again, the deduplication component 543 may determine whether a data content to be stored in the cloud storage server cluster 200 is duplicated with another data content already stored in the cloud storage server cluster 200. A deduplication operation in accordance with some embodiments of the present disclosure is to store a pointer to the aforementioned duplicated data content already stored in the cloud storage sever cluster 200 instead of the data content itself when the data content to be stored is duplicated with another data content in the cloud storage sever cluster 200. The purpose of the deduplication is to minimize the total storage space required for storing data contents having duplicated portions. Instead of storing all of the duplicated portions, storing one copy of the duplicated portions and pointers for identifying and retrieving the copy may significantly save the total space. The deduplication operation may generally be expressed in two simplified steps: finding data content collision (data contents that are duplicated with another) and storing a copy for a collided data content and pointers (e.g. the address of the copy) along with identifications (e.g. metadata of a file) for other collided data contents instead. Hashing is often applied in finding data content collision. A hash may be a transformation of a string of characters (e.g., data contents) into a shorter fixed-length value or key that represents the original string. In some embodiments, hashing is used to index and retrieve data contents in the cloud storage server cluster 200. It is generally faster to find a data content using the shorter hashed index. In some embodiments, a hashing function is used to create an indexed version of the represented value corresponding to data contents. A Hash function may utilize non-encrypted schemes such as division-remainder method, folding, radix transformation, digit rearrangement, or encrypted schemes such as MD2, MD4, MD5, the Secure Hash Algorithm (SHA), and the like. For example, in one embodiment, a file may be partitioned into a fixed sized (e.g. 2 megabytes) data chunks as data contents, while hash data having a smaller size (e.g. 256 kilobits) may be respectively generated corresponding to the data contents.

In some embodiments, the exemplary the deduplication component 543 may be configured to generate a hash associated with a corresponding data content (e.g., a block/chunk of data of a file) to be upload to the cloud storage server cluster 200. The deduplication component 543 may send the hash to the cloud storage server cluster 200 for checking data collision before uploading the data content. If no data collision occurs, the client device 100 may upload the data content to the cloud storage server cluster 200. If data collision occurs, there would be no need to upload the duplicated data content to the cloud storage server cluster 200. The cloud storage server cluster 200 may store a pointer along with an identification of the data content instead of storing the data content itself. In some implementations, a deduplication policy may be maintained by the deduplication component 543. The deduplication policy may define one or more rules dictating whether to perform deduplication operation by the client device 100. For example, some client devices may lack the necessary computing power for generating a hash for data contents to be uploaded. In such instances, the deduplication component 543 may upload the data content to the cloud storage sever cluster 200 directly, so as to delegate the hashing generation and collision checking tasks to the cloud storage sever cluster 200 (e.g., server-side hash generation). Other factors may also be involved in the deduplication policy such as bandwidth availability for the client device 100. In some embodiments, multiple client devices in accordance with the present disclosure may access the cloud storage server cluster 200. Storage volumes may be respectively allocated for the client devices storing data contents. In some implementations, a copy of the non-duplicated data contents may be reserved among the allocated storage volumes for the deduplication operation. Metadata of data contents in the respective client devices may be uploaded to the cloud storage server cluster 200 as a reference for identifying collided data contents belong to the respective data contents. In some implementations, an identification generated from the metadata of the collided data contents and a pointer for accessing a copy of the collided data contents stored independently may be stored for replacing other collided data contents. Therefore, a global deduplication operation for different storage volumes (e.g. storage volume 550c) of different client devices (e.g. client device 100) may be provided.

The upload management component 545 may send data contents to be stored in the cloud storage server cluster 200. The upload management component 545 may also maintain an uploading policy containing rules determining whether/when to upload data contents to the cloud storage server cluster 200. The uploading policy may also be associated with several factors such as bandwidth available for the client device 100, battery level of the client device 100 and available cache storage 470. For example, the upload management component 545 may upload the data contents to the cloud storage server cluster 200 while bandwidth available for the client device 100 accessing the internet meeting a specific level. The upload management component 545 may also upload data contents to the cloud storage server cluster 200 only if battery level of the client device 100 exceeds a specific level. In addition, the upload management component 545 may upload data contents to the cloud storage server cluster 200 if the available space for cache storage 570 is under a specific level. In one embodiment of the present disclosure, the detection of malicious data alteration may be activated during file uploading for information security reasons. In another embodiment of the present disclosure, the detection may be deactivated since the file deletions are not initiated by ransomware but the hybrid cloud file system 510 instead.

The fetching management component 547 may download data contents to be processed or prefetched from the cloud storage server cluster 200. In some implementations, the data contents downloaded may be temporarily kept in memory of the client device 100 and/or stored in the cache storage 570. The fetching management component 547 may request data contents from the cloud storage server cluster 200 according to a download request from the user. The fetching management component 547 may further request data contents the prefetching plan maintained by the prefetch management component 541.

FIG. 7D illustrates exemplary network architecture of the cloud storage system in accordance with some embodiments of the present disclosure. Although the exemplary environment is presented as an Internet-based environment for purposes of explanation, it should be understood that different network environments may be used, as appropriate, to implement various embodiments. The exemplary environment includes a plurality of client devices 110a-d capable of sending/receiving different type of data content over the network 300. The client devices may include a smart phone 110a capable of running mobile applications and accessing files through the mobile applications, a laptop computer 110b capable of accessing and processing files through a file system implemented therein, a wearable device 110c having sensors for collecting data and limited resources for processing only collected data, a web camera 110d collecting large sized video data and generally having no local storage for the video data, and the like.

The cloud storage sever cluster 200 (not shown in FIG. 7C) may include one or more storage nodes 210a-c having storage devices for storing data. Storage volumes in each storage node 210 may be aggregated and allocated for each client device 100. The total storage capacity may be extended by implementing more storage nodes. A management server 220 may serve allocating storage volumes provided by the storage nodes 210 for each of the client devices 100a-d. In some embodiments, the management server 220 may be operable, through logic associated therewith, to receive instructions from the client devices 100a-d and obtain, update, or otherwise process data in response thereto. For instance, a user may submit a request for a certain type of data content. The management server 220 may access the user information to verify the identity of the user and grant permission to access the data content stored in the storage nodes 210. The data content may then be returned to the user's client device in a timely and efficient manner as if the data content is hosted locally onboard the client device.

A deduplication server 230 may be arranged between the storage nodes 210 and the client devices 100a-d. In a cloud storage system where the associated storage hardware equipment is costly and the network bandwidth resource is scarce, the implementation of the deduplication server 230 may collaboratively provide data deduplication capabilities that facilitates effective utilization of existing storage capacity and reduces the bandwidth requirement in a cloud-based system. The deduplication server 230 may cooperate with the deduplication component 443 of the client devices 100a-d depicted in FIG. 7C. By way of example, the addition of a deduplication mechanism in the cloud storage system is able to reduce the required storage capacity since only the unique data/file is stored. Aside from the benefit of storage space saving, equipment acquisition costs, power consumptions, device cooling requirements, and network bandwidth requirements may be reduced.

In some implementations, a user behavior analysis server 240 may be contained in the cloud storage server cluster 200. The user behavior analysis server 240 may collaborate with the user behavior analysis module 140 of the operating system 500 in the client devices 100a-d to collect and analysis file access behavior. In one embodiment of the present disclosure, the analysis may be applied for improving the prefetching plan by providing the analysis to the prefetch management component 541. In one embodiment, the analysis may also be applied for increasing/optimizing patterns of malicious data alterations by providing the analysis to the pattern recognizer 421 of the aforementioned anti-malware system 400 depicted in FIG. 5. For instance, each of the client devices 100a-d and the storage nodes 210a-c may incorporate the aforementioned anti-malware system 400. While malicious data alteration found in one of the client devices 100a-d and the storage nodes 210a-c, the anti-malware system 400 may transmit the history of data access operation corresponding to the malicious data alteration to the user behavior analysis server 240 for updating patterns of malicious data alteration by malware from the history. The user behavior analysis server 240 may provide the updated patterns of malicious data alteration to each of the client devices 100a-d and the storage nodes 210a-c as a new basis for the pattern recognizer 421 of each anti-malware system 400 incorporated therein identifying malicious data alterations. Therefore, once malicious data alterations found in one of the multiple devices, related access history may be transmitted to the user behavior analysis server 240 for identifying related patterns of malicious data alterations (“new patterns”). The user behavior analysis server 240 may then provide the new patterns of malicious data alterations to the multiple devices for the anti-malware systems 400 incorporated therein identifying malicious data alterations with the new patterns. As a result, the user behavior analysis server 240 may update patterns of malicious data alteration based on data access histories corresponding to malicious data alteration in the devices incorporated with the anti-malware systems 400 and may provide the updated patterns to the devices incorporated with the anti-malware systems 400. Any malicious data alterations found in the devices may contribute to the other devices with its corresponding data access history.

In some embodiments, additional servers may be included in the cloud storage server cluster 200. For instance, the system environment may include a web server (not shown) for receiving requests from user devices and serving content thereto in response. The cloud storage server cluster 200 may further include an application server (not shown), which includes appropriate hardware and software for integrating with the data stored therein as needed to execute aspects of one or more applications for the client device and handling a majority of the data access and business logic for an application. The handling of data requests and responses, as well as the delivery of content between one or more client devices (e.g. the client device 110) and the cloud storage server cluster 200, may be handled by the web server.

FIG. 7E illustrates an exemplary anti-malware system implemented within the client device 100 including the hybrid cloud file system 510 in accordance with some embodiments of the present disclosure. In one embodiment of the present disclosure, the exemplary anti-malware (especially ransomware) system 400 may be provided capable for detecting malicious data alteration by malware (e.g. file encryption by ransomware) and managing baits for detecting malicious data alteration. For example, the hybrid cloud file system 510 may halt file upload to the cloud storage server cluster 200 upon the anti-malware system 400 finding files in cache storage 570 encrypted by ransomware. In one embodiment of the present disclosure, the hybrid cloud file system 510 may further request and fetch the corresponding data contents physically stored in the cloud storage server cluster 200 to replace the encrypted files in the cache storage 570. In another embodiment of the present disclosure, the hybrid cloud file system 510 may only fetch “pinned files” from the cloud storage server cluster 200 and delete other “unpinned files” in the cache storage 570 since data contents are physically stored in the cloud storage server cluster 200, and copies of the data contents stored in the cache storage 570 are merely for quick access. In one embodiment of the present disclosure, for data contents physically stored in cloud storage server cluster 200 and including only hash values in the client device 100 for deduplication, the cloud storage server cluster 200 may generate hash values from data contents corresponding to the files suspicious of being encrypted by ransomware and send the hash values to the client device 100 for recovery. Referring to FIG. 7D again, the exemplary anti-malware system 400 may include a bait management module 410 for creating the aforementioned baits in the cache storage 570 and maintaining a list of baits for detecting file encryption (or other malicious data alterations) by ransomware. The exemplary anti-malware 400 may further include a malware detection module 420 for detecting file encryption by ransomware, in one embodiment of the present disclosure, by monitoring file status of the baits or data alteration instructions corresponding to the baits. Once baits encrypted by ransomware are found, the malware detection module 420 may acknowledge the synching management module 540 of the hybrid cloud file system 510 to halt the file uploads and to further fetch files physically stored in the cloud storage server cluster 200 for the cache management module 530 replacing the files stored in the cache storage 570 with the fetched files. In one embodiment of the present disclosure, the malware detection module 420 may also receive patterns generated based on malicious data alteration in other devices from the user behavior analysis server 240 and update the patterns of malicious data alteration maintained by it. In some implementations, the malware detection module 420 may also provide its monitoring history corresponding to the identified malicious data alterations to the user behavior analysis server 240 for generating new patterns.

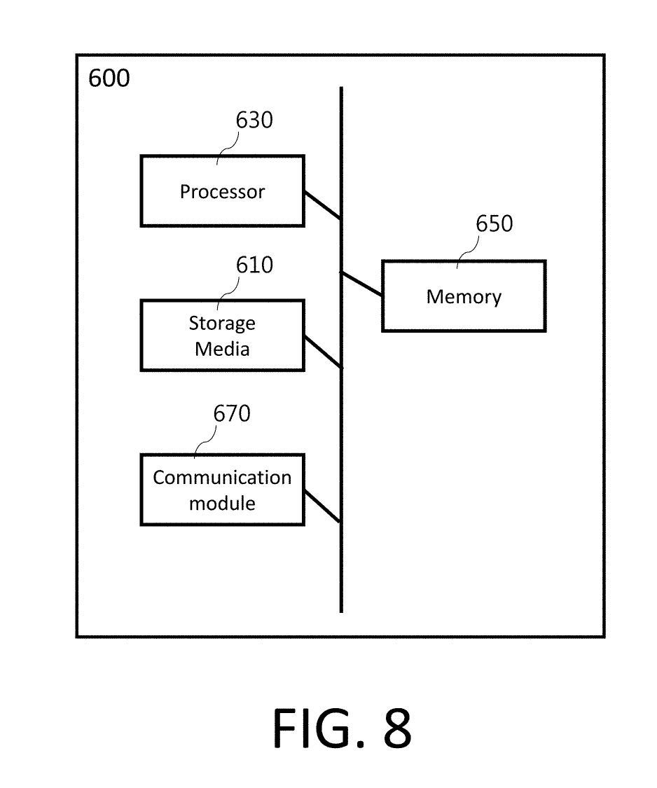

FIG. 8 illustrates an exemplary electronic device 600 implemented with the exemplary anti-malware system 400 in accordance with some embodiments of the present disclosure. In one embodiment of the present disclosure, the electronic device 600 may be an illustration of the client device 100. As described in previous paragraphs, the electronic device 600 may include a local storage medium 610 for storing files, and in some implementations, providing cache storage 570. In addition, the electronic device 600 may generally include a processor 630 for executing instructions of the anti-malware system 400 (and the operating system 500 in some embodiments of the present disclosure), a memory 650 connected to the processor for temporarily keeping files to be processed by the processor 630, a communication module 670 for accessing the network 300 for uploading/downloading files to/from the cloud storage server cluster 200. The processor 630 may create baits in the storage medium 610 and detect ransomware infection by checking whether baits included in the files to be uploaded to the cloud storage server cluster 200 through the communication module 670 in one embodiment of the present disclosure. Once, ransomware infection is found, the processor 630 may further determine scope of files suspicious of being encrypted by ransomware and request corresponding copies from the cloud storage server cluster 200 through the communication module 670. The communication module 670 may receive the files from the cloud storage server cluster 200 for the processor 630 to replace the files suspicious of being encrypted in the storage medium 610 with the received files.

Referring to FIG. 8 again, in another embodiment of the present disclosure, the electronic device 600 may be an illustration of a cloud storage server in the cluster 200. The electronic device 600 may include a storage medium 610 for storing files received from the client device 100. In addition, the electronic device 600 may generally include a processor 630 for executing instructions of the anti-malware system (and the operating system 500 in some embodiments of the present disclosure), a memory 650 connected to the processor for temporarily keeping files to be processed by the processor 630, a communication module 670 for accessing the network 300 for receiving/transmitting files from/to the client device 100. The processor 630 may maintain a list of baits created by the client device 100 and detect ransomware infection by checking whether baits included in the files received from to the client device 100 through the communication module 670 in one embodiment of the present disclosure. In one embodiment of the present disclosure, the electronic device 600 synchronized at least a portion of its files according to file updates received from the client device 100. The processor 630 may further reserve copies of files to be updated/deleted due in response to file updates received for recovery of files once finding files encrypted (infected) by ransomware. Once ransomware infection is found, the processor 630 may further determine scope of files suspicious of being encrypted by ransomware and replace the suspicious files with the corresponding reserved copies in the storage medium 610. In one embodiment of the present disclosure, the electronic device 600 may receive file recovery request from the client device 100 through the communication module 670 and send the aforementioned reserved copies back to the client device 100 through the communication module 670.

The aforementioned local storage medium 610 in FIG. 8 may be a computer readable recording medium embedded in the electronic device 600 and may further include ROM, RAM, EPROM, EEPROM, hard disk, solid state drive, soft disk, CD-ROM, DVD-ROM or other forms of electronic, electromagnetic or optical recording medium. In some implementations, the local storage medium 610 may further be one or more interfaces capable of accessing the aforementioned computer readable recording medium instead. The processor 630 may be a processor or a controller for executing the program instruction in the memory 650 and may further include an embedded system or an application specific integrated circuit (ASIC) having embedded program instructions. The communication module 670 may be a wired network interface or a wireless transceiver adopting one or more of customized protocols or following existing/de facto standards such as Ethernet, IEEE 802.11 or IEEE 802.15 series, Wireless USB or telecommunication standards such as GSM, CDMAone, CDMA2000, WCDMA, TD-SCDMA, WiMAX, 3GPP-LTE, TD-LTE and LTE-Advanced.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A machine implemented method for detecting malicious alteration of data in a first computing device communicably connected to a second computing device, wherein the first computing device transmits file update information and updated files to the second computing device, the method comprising:
generating, at the first computing device, one or more files as baits in folders including files and file folders therein in the first computing device;
checking, at the first computing device, file status of the baits for identifying data alteration corresponding to the baits; and
if data alteration corresponding to the baits is identified:
halting, at the first computing device, transmission of file update information and updated files from the first computing device to the second computing device; and
generating, at the first computing device, a message corresponding to malicious alteration of data.

2. The method in claim 1, further comprising:
checking, at the first computing device, whether at least one criterion corresponding to the file update information is met; and
halting, at the first computing device, transmission of file update information and updated files from the first computing device to the second computing device only if the at least one criterion is met alone with identification of data alteration corresponding to the baits.

3. The method in claim 2, further comprising:
halting, at the first computing device, transmission of file update information and updated files from the first computing device to the second computing device for a period if the at least one criterion is met; and
reactivating, at the first computing device, transmission of file update information and updated files from the first computing device to the second computing device if:
non of said at least one criterion being met in the first computing device during the period; or
no data alteration corresponding to the baits being identified during the period.

4. The method in claim 2, wherein the at least one criterion include a threshold of file update frequency.

5. The method in claim 1, further comprising:
identifying, at the first computing device, a scope of files corresponding to malicious alteration of data based on data alteration corresponding to the baits identified;
requesting, at the first computing device, copies corresponding to the scope of files from the second computing device; and
receiving, at the first computing device, the copies from the second computing device and replacing the scope of files corresponding to malicious alteration of data with the copies.

6. The method in claim 1, wherein the data alteration corresponding to the baits includes encryption or deletion of the baits.

7. The method in claim 2, wherein a third computing device communicably connected to the second computing device and a group of computing device including the first computing device generates patterns of malicious alteration of data from data access histories collected from the group of the computing devices, and the method further comprising:
transmitting data access history during a period of time associated with the data alteration corresponding to the baits from the first computing device to the third computing device for generating patterns of malicious alteration of data;
receiving, at the first computing device, one or more patterns of malicious alteration of data from the third computing device; and
updating, at the first computing device, the at least one criterion to include identification of the patterns.

8. A machine implemented method for detecting malicious alteration of data in a first computing device communicably connected to a second computing device, wherein the first computing device configured to obtain authentications for an authorized cloud storage volume in the second computing device, define a hybrid cloud storage volume in the first computing device corresponding to the authorized cloud storage volume for files in the hybrid cloud storage volume to be physically stored in the authorized cloud storage volume, define a cache storage with an allocated storage capacity in the first computing device for reserving copies of portion of files in the hybrid cloud storage volume for processing of files and synchronize updates of files in the hybrid cloud storage volume to the authorized cloud storage volume, and the method comprising:
checking, at the first computing device, one or more patterns of malicious alteration of data in the hybrid cloud storage volume based on file update information before transmitting the file update information and updated files for the second device manipulating files in the authorized cloud storage volume according to the file update information and updated files;
halting, at the first computing device, transmission of file update information and updated files from the first computing device to the second computing device if at least one pattern of malicious alteration of data is identified; and
providing, at the first computing device, a message corresponding to malicious alteration of data.

9. The method in claim 8, further comprising:
requesting, at the first computing device, one or more files stored in authorized cloud storage volume from the second computing device based on the at least one pattern of malicious alteration of data;
receiving, at the first computing device, the one or more files from the second computing device; and
replacing one or more reserved copies in the cache storage with the one or more files based on the at least one pattern of malicious alteration of data.

10. The method in claim 8, wherein the one or more patterns of malicious alteration of data comprise a threshold of file update frequency in the cache storage.

11. The method in claim 8, further comprising:
reactivating, at the first computing device, transmission of file update information and updated files if none of the one or more patterns of malicious alteration of data is identified during the halting of the transmission for a specific period.

12. The method in claim 8, further comprising:
generating, at the first computing device, one or more files as baits in the cache storage; and
wherein the one or more patterns of malicious alteration of data comprise data alteration corresponding to the baits in the cache storage.

13. The method in claim 12, wherein the data alteration corresponding to the baits includes encryption or deletion of the baits.

14. The method in claim 8, wherein a third computing device communicably connected to the second computing device and a group of computing device including the first computing device generates updated patterns of malicious alteration of data from data access histories collected from the group of the computing devices, and the method further comprising:
transmitting data access history during a period of time associated with the identification of the at least one pattern of malicious alteration of data from the first computing device to the third computing device for generating updated patterns of malicious alteration of data;
receiving, at the first computing device, one or more updated patterns of malicious alteration of data from the third computing device; and
amending, at the first computing device, the updated patterns from the third computing device to the one or more patterns of malicious alteration of the data in the first computing device.

15. A non-transitory machine readable medium storing a program for detecting malicious alteration of data in a first computing device comprising communication module capable of transmitting file update information and updated files to a second computing device, the program executable by at least one processing unit of the first computing device, the program comprising sets of instructions for:
generating one or more files as baits in folders including files and file folders therein in the first computing device;
checking file status of the baits for identifying data alteration corresponding to the baits; and
if data alteration corresponding to the baits is identified:
halting transmission of file update information and updated files from the first computing device to the second computing device; and
generating a message corresponding to malicious alteration of data.

16. The non-transitory machine readable medium of claim 15, wherein the program further comprising a set of instructions for:
checking whether at least one criterion corresponding to the file update information is met; and
halting transmission of file update information and updated files from the first computing device to the second computing device only if the at least one criterion is met alone with identification of data alteration corresponding to the baits.

17. The non-transitory machine readable medium of claim 16, wherein the program further comprising a set of instructions for:
halting transmission of file update information and updated files from the first computing device to the second computing device for a period if the at least one criterion is met; and
reactivating transmission of file update information and updated files from the first computing device to the second computing device if:
non of said at least one criterion being met in the first computing device during the period; or
no data alteration corresponding to the baits being identified during the period.

18. The non-transitory machine readable medium of claim 16, wherein the at least one criterion include a threshold of file update frequency.

19. The non-transitory machine readable medium of claim 15, wherein the program further comprising a set of instructions for:
identifying a scope of files corresponding to malicious alteration of data based on data alteration corresponding to the baits identified;
requesting copies corresponding to the scope of files from the second computing device; and
receiving the copies from the second computing device and replacing the scope of files corresponding to malicious alteration of data with the copies.

20. The non-transitory machine readable medium of claim 15, wherein the data alteration corresponding to the baits includes encryption or deletion of the baits.

21. The non-transitory machine readable medium of claim 15, wherein a third computing device communicably connected to the second computing device and a group of computing device including the first computing device generates patterns of malicious alteration of data from data access histories collected from the group of the computing devices, and the program further comprising a set of instructions for:
transmitting data access history during a period of time associated with the data alteration corresponding to the baits from the first computing device to the third computing device for generating patterns of malicious alteration of data;
receiving one or more patterns of malicious alteration of data from the third computing device; and
updating the at least one criterion to include identification of the patterns.

22. A non-transitory machine readable medium storing a program for detecting malware infection of files in a first computing device comprising communication module capable of communicably connecting to a second computing device, the program executable by at least one processing unit of the first computing device, the program comprising sets of instructions for:
obtaining authentications for an authorized cloud storage volume in the second computing device,
defining a hybrid cloud storage volume in the first computing device corresponding to the authorized cloud storage volume for files in the hybrid cloud storage volume to be physically stored in the authorized cloud storage volume;
defining a cache storage with an allocated storage capacity in the first computing device for reserving copies of portion of files in the hybrid cloud storage volume for processing of files;
synchronizing updates of files in the hybrid cloud storage volume to the authorized cloud storage volume;
checking one or more patterns of malicious alteration of data in the hybrid cloud storage volume based on updates of files before synchronizing for the second device manipulating files in the authorized cloud storage volume according to the updates of files;
halting the synchronization of the updates of files if at least one pattern of malicious alteration of data is identified; and
providing a message corresponding to malicious alteration of data.

23. The non-transitory machine readable medium of claim 22, wherein the program further comprising a set of instructions for:
requesting one or more files stored in authorized cloud storage volume from the second computing device based on the at least one pattern of malicious alteration of data;
receiving the one or more files from the second computing device; and
replacing one or more reserved copies in the cache storage with the one or more files based on the at least one pattern of malicious alteration of data.

24. The non-transitory machine readable medium of claim 22, wherein the one or more patterns of malicious alteration of data comprise a threshold of file update frequency in the cache storage.

25. The non-transitory machine readable medium of claim 22, wherein the program further comprising a set of instructions for:
reactivating the synchronization of the updates of files if none of the one or more patterns of malicious alteration of data is identified during the halting of the transmission for a specific period.

26. The non-transitory machine readable medium of claim 22, wherein the program further comprising a set of instructions for:
generating one or more files as baits in the cache storage; and
wherein the one or more patterns of malicious alteration of data comprise data alteration corresponding to the baits in the cache storage.

27. The non-transitory machine readable medium of claim 26, wherein the data alteration corresponding to the baits includes encryption or deletion of the baits.

28. The non-transitory machine readable medium of claim 22, wherein a third computing device communicably connected to the second computing device and a group of computing device including the first computing device generates patterns of malicious alteration of data from data access histories collected from the group of the computing devices, and the program further comprising a set of instructions for:
transmitting data access history during a period of time associated with the identification of the at least one pattern of malicious alteration of data from the first computing device to the third computing device for generating updated patterns of malicious alteration of data;
receiving one or more updated patterns of malicious alteration of data from the third computing device; and
amending the updated patterns from the third computing device to the one or more patterns of malicious alteration of the data in the first computing device.

29. A computing device, comprising:
a storage medium capable of storing files including one or more files as baits therein;
a communication element capable of communicably connected to a remote apparatus;
memory; and
a processor coupled to the memory and configured to execute instructions stored in the memory to cause this processor to:
while files in the storage medium being updated, transmit file update information and updated files to the remote apparatus for remote apparatus manipulating files therein according to the file update information and updated files;
before transmission of the file update information and the updated files to the remote apparatus, check file status of the baits for identifying data alteration corresponding to the baits; and
if data alteration corresponding to the baits is identified:
halt the transmission of the file update information and the updated files from the
computing device to the remote apparatus device; and
generate a message corresponding to malicious alteration of data .

30. The computing device of claim 29, wherein instructions stored in the memory to cause this processor to check file status of the baits comprises instructions to cause the processor to generate files as the baits and store the generated baits in the storage medium.

31. The computing device of claim 29, wherein instructions stored in the memory to cause this processor to halt transmission comprises instructions to cause the processor to:
check whether at least one criterion corresponding to the file update information is met; and
halt transmission of file update information and updated files to the remote apparatus through the communication element only if the at least one criterion is met alone with identification of data alteration corresponding to the baits.

32. The computing device of claim 29, wherein instructions stored in the memory to cause this processor to halt transmission comprises instructions to cause the processor to:
halt the transmission to the remote apparatus through the communication element for a time period once the files to be transmitted to the remote apparatus meeting the at least one criterion; and
reactivate the transmission to the remote apparatus through the communication element under the conditions including:
none of the at least one criterion being met during the specific time period; or
no baits or no files having the same file names as at least one of the baits being identified in the files to be transmitted to the remote apparatus.

33. The computing device of claim 31, wherein the at least one criterion include a threshold of file update frequency.

34. The computing device of claim 29, wherein instructions stored in the memory to cause this processor to halt transmission comprises instructions to cause the processor to:
identify a scope of files corresponding to malicious alteration of data based on data alteration corresponding to the baits identified;
request copies corresponding to the scope of files from the remote apparatus; and
receive the copies from the remote apparatus and replace the scope of files corresponding to malicious alteration of data with the copies.

35. The computing device of claim 29, wherein the data alteration corresponding to the baits includes encryption or deletion of the baits.

36. The computing device of claim 31, wherein a server communicably connected to the remote apparatus and a group of edge nodes including the computing device generates patterns of malicious alteration of data from data access histories collected from the group of edge nodes, and the instructions stored in the memory to cause this processor to halt transmission comprises instructions to cause the processor to:
transmit data access history during a period of time associated with the data alteration corresponding to the baits to the server for generating patterns of malicious alteration of data;
receive one or more patterns of malicious alteration of data from the server; and
update the at least one criterion to include identification of the patterns.

37. A computing device, comprising:
a storage medium capable of storing files therein;
a communication element capable of communicably connected to a cloud storage server;
memory; and
a processor coupled to the memory and configured to execute instructions stored in the memory to cause this processor to:
obtain by the communication element an authentication for an authorized cloud storage volume in the cloud storage server and corresponding volume information;
define a hybrid cloud storage volume corresponding to the authorized cloud storage volume based on the volume information, and wherein the hybrid cloud storage volume has a file directory;
receive one or more files from the storage medium via the memory, and wherein the one or more files are to be stored in the file directory of the hybrid cloud storage volume;
check one or more patterns of malicious alteration of data in the hybrid cloud storage volume based on the one or more files; and
upload the one or more files by the communication element to the authorized cloud storage volume in the cloud storage server if no pattern of malicious alteration of data is identified; and
halt uploading to the cloud storage server by the communication element and provide a message corresponding to malicious alteration of data if at least one of the patterns of malicious alteration of data is identified.

38. The computing device of claim 37, wherein instructions stored in the memory to cause this processor to halt file the uploading comprises instructions to cause the processor to:
if at least one of the patterns of malicious alteration of data is identified:
request by the communication element the cloud storage server for files in the authorized cloud storage volume corresponding to files stored in the storage medium based on the file directory of the hybrid cloud storage volume;
receive by the communication element the files from the cloud storage server; and
replace the files in the storage medium with the files received from the storage server.

39. The computing device of claim 37, wherein the one or more patterns of malicious alteration of data comprise a threshold of file update frequency in the cache storage.

40. The computing device of claim 37, wherein instructions stored in the memory to cause this processor to halt the uploading comprises instructions to cause the processor to:
upload the one or more files by the communication element to the authorized cloud storage volume in the cloud storage server if no pattern of malicious alteration of data is identified during the halting of the uploading for a specific period.

41. The computing device of claim 37, wherein instructions stored in the memory to cause this processor to check of malicious alteration of data comprises instructions to:
generate one or more files as baits in the file directory of the hybrid cloud storage volume to be physically stored in the storage medium; and
wherein the one or more patterns of malicious alteration of data comprise data alteration corresponding to the baits in the storage medium.

42. The computing device of claim 41, wherein the data alteration corresponding to the baits includes encryption or deletion of the baits.

43. The computing device of claim 37, wherein a server communicably connected to the remote apparatus and a group of edge nodes including the computing device generates patterns of malicious alteration of data from data access histories collected from the group of edge nodes, and the instructions stored in the memory to cause this processor to halt the uploading comprises instructions to cause the processor to:
transmit, through the communication element, data access history of the file directory of the hybrid cloud storage volume during a period of time associated with the identification of the at least one pattern of malicious alteration of data to the server for generating updated patterns of malicious alteration of data;
receive, through the communication element, one or more updated patterns of malicious alteration of data from the server; and
amending the updated patterns from the server to the one or more patterns of malicious alteration of the data in the storage medium.

44. A machine implemented method for detecting malicious alteration of data in a second computing device communicably connected to a first computing device, wherein one or more files as baits are stored in the first computing device, and wherein the second computing device receives file update information and updated files and manipulates files stored therein accordingly, the method comprising:
checking, at the second computing device, at least one criterion corresponding to malicious alteration of data in the first computing device, wherein the at least one criterion comprises data alteration of the baits in the first computing device; and
if the at least one criterion corresponding to malicious alteration of data in the first computing device is met, halting, at the second computing device, file manipulation corresponding to file update information and updated files received from the first computing device.

45. The method in claim 44, wherein the data alteration corresponding to the baits includes encryption or deletion of the baits.

46. The method in claim 44, wherein the at least one criterion comprises receiving of a message corresponding to data alteration of the baits from the first computing device.

47. The method in claim 44, wherein the at least one criterion comprises identifying data alteration of the baits according to the file update information and updated files received from the first computing device.

48. The method in claim 44, wherein the at least one criterion comprises a threshold of file update frequency, and wherein the file update frequency is calculated based on the file update information and the updated files received from the first computing device.

49. The method in claim 44, further comprising:
reactivating, at the second computing device, the file manipulation corresponding to the file update information and the updated files if none of the at least one criterion is met during a period of the halting of the file manipulation.

50. The method in claim 44, wherein if the at least one criterion corresponding to malicious alteration of data in the first computing device is met, the method further comprising:
determining, at the second computing device, a scope of files in the second computing device corresponding to the malicious alteration of data in the first computing device; and
retrieving, at the second computing device, the scope of files and transmitting to the first computing device.

51. The method in claim 44, further comprising:
reserving, at the second computing device, copies of altered files corresponding to manipulation of files in the second computing device according to the file update information and updated files from the first computing device; and
if the at least one criterion corresponding to malicious alteration of data in the first computing device is met:
determining, at the second computing device, a scope of maliciously altered files in the second computing device corresponding to the malicious alteration of data in the first computing device;
retrieving, at the second computing device, copies corresponding to the scope of maliciously altered files in the second computing device; and
replacing, at the second computing device, the scope of maliciously altered files with the retrieved copies.

52. The method in claim 44, wherein the second computing device is communicably connected with a third computing device transmitting file update information and updated files for the second computing device manipulating files stored therein accordingly, and the method further comprising:
if the at least one criterion corresponding to malicious alteration of data in the first computing device is met, receiving, at the second computing device, data access history during a period of time associated with the data alteration of the baits;
generating, at the second computing device, at least one pattern of malicious alteration of data; and
halting, at the second computing device, file manipulation corresponding to file update information and updated files received from the third computing device if the at least one pattern of malicious alteration of data is identified based on the file update information and the updated files received from the third computing device.

53. A non-transitory machine readable medium storing a program for detecting malicious alteration of data in a second computing device comprising a communication element capable of receiving file update information and updated files from a first computing device having one or more files stored as baits therein and a processing element capable of manipulating files stored in the second computing device according to the received file update information and updated files from the first computing device, the program executable by the processing element of the second computing device, the program comprising sets of instructions for:
checking, at the second computing device, at least one criterion corresponding to malicious alteration of data in the first computing device, wherein the at least one criterion comprises data alteration of the baits in the first computing device; and
if the at least one criterion corresponding to malicious alteration of data in the first computing device is met, halting, at the second computing device, file manipulation corresponding to file update information and updated files received from the first computing device.

54. The non-transitory machine readable medium of claim 53, wherein the data alteration corresponding to the baits includes encryption or deletion of the baits.

55. The non-transitory machine readable medium of claim 53, wherein the at least one criterion comprises receiving of a message corresponding to data alteration of the baits from the first computing device.

56. The non-transitory machine readable medium of claim 53, wherein the at least one criterion comprises identifying data alteration of the baits according to the file update information and updated files received from the first computing device.

57. The non-transitory machine readable medium of claim 53, wherein the at least one criterion comprises a threshold of file update frequency, and wherein the file update frequency is calculated based on the file update information and the updated files received from the first computing device.

58. The non-transitory machine readable medium of claim 53, wherein the program further comprising a set of instructions for:
reactivating, at the second computing device, the file manipulation corresponding to the file update information and the updated files if none of the at least one criterion is met during a period of the halting of the file manipulation.

59. The non-transitory machine readable medium of claim 53, wherein the program further comprising a set of instructions for:
if the at least one criterion corresponding to malicious alteration of data in the first computing device is met:
determining, at the second computing device, a scope of files in the second computing device corresponding to the malicious alteration of data in the first computing device; and
retrieving, at the second computing device, the scope of files and transmitting to the first computing device.

60. The non-transitory machine readable medium of claim 53, wherein the program further comprising a set of instructions for:
reserving, at the second computing device, copies of altered files corresponding to manipulation of files in the second computing device according to the file update information and updated files from the first computing device; and
if the at least one criterion corresponding to malicious alteration of data in the first computing device is met:
determining, at the second computing device, a scope of maliciously altered files in the second computing device corresponding to the malicious alteration of data in the first computing device;
retrieving, at the second computing device, copies corresponding to the scope of maliciously altered files in the second computing device; and
replacing, at the second computing device, the scope of maliciously altered files with the retrieved copies.

61. The non-transitory machine readable medium of claim 53, wherein the second computing device is communicably connected with a third computing device transmitting file update information and updated files for the second computing device manipulating files stored therein accordingly, and wherein the program further comprising a set of instructions for:
if the at least one criterion corresponding to malicious alteration of data in the first computing device is met:
receiving, at the second computing device, data access history during a period of time associated with the data alteration of the baits from the first computing device; and
generating, at the second computing device, at least one pattern of malicious alteration of data; and
checking, at the second computing device, for the at least one pattern of malicious alteration of data based on the file update information and the updated files received from the third computing device; and
halting, at the second computing device, file manipulation corresponding to file update information and updated files received from the third computing device if the at least one pattern of malicious alteration of data is identified.

62. An apparatus, comprising:
a storage medium capable of storing files therein;
a communication element capable of communicably connected to a first computing device;
memory; and
a processor coupled to the memory and configured to execute instructions stored in the memory to cause this processor to:
receive, by the communication element, file update information and updated files from the first computing device;
manipulate files in the storage medium according to the file update information and the updated files;
check at least one criterion corresponding to malicious alteration of data in the first computing device; and
if the at least one criterion corresponding to malicious alteration of data in the first computing device is met, halt the manipulation of files in the storage medium corresponding to the file update information and updated files received from the first computing device; and
wherein the computing device stores one or more files as baits to malicious alteration of data, and the at least one criterion comprises data alteration of the baits in the first computing device.

63. The apparatus of claim 62, wherein the data alteration corresponding to the baits includes encryption or deletion of the baits.

64. The apparatus of claim 62, wherein the at least one criterion comprises receiving of a message corresponding to data alteration of the baits from the first computing device.

65. The apparatus of claim 62, wherein instructions stored in the memory to cause the processor to check the at least one criterion further comprises instructions to cause the processor to identify data alteration of the baits according to the file update information and the updated files received from the first computing device, and wherein the at least one criterion comprises identification of data alteration of the baits from the file update information and the updated files.

66. The apparatus of claim 62, wherein instructions stored in the memory to cause the processor to check the at least one criterion further comprises instructions to cause the processor to calculate file update frequency based on the file update information and the updated files received from the first computing device, and wherein the at least one criterion comprises a threshold of the file update frequency.

67. The apparatus of claim 62, wherein instructions stored in the memory to cause the processor to halt the manipulation of files further comprises instructions to cause the processor to reactivate manipulation of files corresponding to the file update information and the updated files if none of the at least one criterion is met during a period of the halting.

68. The apparatus of claim 62, wherein instructions stored in the memory to cause the processor to halt the manipulation of files further comprises instructions to cause the processor to:
determine a scope of files in storage medium corresponding to the malicious alteration of data in the first computing device;
retrieve the scope of files from the storage medium; and
transmit the scope of files to the first computing device through the communication element.

69. The apparatus of claim 62, wherein instructions stored in the memory to cause the processor to manipulate files in the storage medium further comprises instructions to cause the processor to reserve copies of altered files corresponding to the manipulation, and wherein instructions stored in the memory to cause the processor to halt the manipulation of files further comprises instructions to cause the processor to:
determine a scope of maliciously altered files in storage medium corresponding to the malicious alteration of data in the first computing device;
retrieve reserved copies corresponding the scope of maliciously altered files; and
replace the scope of maliciously altered files in the storage medium with the retrieved copies.

70. The apparatus of claim 62, wherein instructions stored in the memory to cause the processor to halt the manipulation of files further comprises instructions to cause the processor to:
receive, through the communication element, data access history during a period of time associated with the data alteration of the baits from the first computing device; and
generate at least one pattern of malicious alteration of data based on the data access history from the first computing device; and
wherein the communication element is capable of communicably connected to a second computing device, and instructions stored in the memory further cause the processor to:
receive file update information and updated files from the second computing device through the communication element;
manipulate files in the storage medium according to the file update information and updated files from the second computing device;
check for the at least one pattern of malicious alteration of data based on the file update information and the updated files from the second computing device; and
halt the manipulation of files corresponding to the file update information and the updated files from the second computing device if the at least one pattern of malicious alteration of data is identified.

71. A storage system comprising:
a cloud service end; and
one or more edge nodes communicably connected to the cloud service end for transmitting file update information and updated files to the cloud service end; and
wherein the cloud service end is configured to allocate one or more storage volumes for the edge nodes respectively and to manipulate, according to the file update information and the updated files received from each of the edge nodes, files in the storage volume allocated for the edge node;
wherein a first edge node of the edge nodes is configured to check for at least one criterion of malicious data alteration and to halt transmission of file update information and updated files therein to the cloud service end if the at least one criterion of malicious data alteration is met;
wherein the cloud service end is configured to check for the at least one criterion of malicious data alteration in a second edge node of the edge nodes including the first edge node based on the file update information and updated files received from the second edge node and to halt manipulation of file in the storage volume allocated to the second edge node if the at least one criterion of malicious data alteration in the second edge node is met; and
wherein one or more files stored in the edge nodes are configured to be baits corresponding to malicious data alteration, and wherein the at least one criterion in at least one of the edge nodes comprises data alteration corresponding to at least one of the baits stored in the at least one of the edge nodes.

72. The storage system of claim 71, wherein the data alteration corresponding to at least one of the baits includes encryption or deletion of the at least one of the baits.

73. The storage system of claim 71, wherein the first edge node is further configured to:
generate at least one of the bait to be stored therein; and
check file status of the at least one of the baits for identifying data alteration corresponding to the at least one of the baits as the at least one criterion of malicious data alteration in the first edge node.

74. The storage system of claim 73, wherein the first edge node equals to the second edge node, and wherein the first edge node is further configured to send a message of malicious data alteration to the cloud service end as the at least one criterion of malicious data alteration in the second edge node for the cloud service end halting the manipulation of file.

75. The storage system of claim 71, wherein the cloud service end is further configured to check files status of the baits corresponding to the file update information and updated files received from the second node for the identification of data alteration as the criterion of malicious data alteration in the second edge node.

76. The storage system of claim 75, wherein the second edge node equals to the first edge node, and wherein cloud service end is further configured to send a message of malicious data alteration to the first edge node as the at least one criterion of malicious data alteration in the first edge node for the first edge node halting the transmission of the file update information and the updated files.

77. The storage system of claim 71, wherein the at least one of the edge nodes is further configured to reactivate the transmission of file update information and updated files therein to the cloud service end if none of the at least one criterion of malicious data alteration in the edge node is met in a period during the halting of the transmission.

78. The storage system of claim 71, wherein the cloud service end is further configured to reactivate the manipulation of file in the storage volume allocated to the edge node if none of the at least one criterion of malicious data alteration in the edge node is met in a period during the halting of the manipulation.

79. The storage system of claim 71, wherein if the at least one criterion of malicious data alteration is met, the first edge node is further configured to:
determine a scope of files in the first edge node based on the meeting of the criterion corresponding to the malicious data alteration in the first edge node;
request the cloud service end for the scope of files in the storage volume allocated to the first edge node and receive the scope of files from the cloud service end; and
replace the scope of files in the first edge node with the corresponding ones received from the cloud service end.

80. The storage system of claim 71, wherein the cloud service end is further configured to:
reserve copies of files in the storage volume allocated to the second edge node before manipulated according to the file update information and updated files from the second edge node;
determine a scope of files in the storage volume allocated to the second edge node based on the meeting of the criterion corresponding to the malicious data alteration in the second edge node; and
retrieve one or more of copies corresponding to the scope of the files and replace the scope of the files with the one or more of the copies.

81. The storage system of claim 71, wherein the first edge node is further configured to:
define a hybrid cloud storage volume having a file directory corresponding to a storage volume allocated to the first edge node;
define a cache storage with an allocated storage capacity in the first edge node for reserving copies of portion of files in the hybrid cloud storage volume for processing of the copies and uploading of the processed copies to replace the corresponding portion of files as file update in the storage volume allocated by the cloud service end;
generate one or more of the baits in file directory of the hybrid cloud storage volume, and wherein the generated baits are physically stored in the cache storage;
request the cloud service end for one or more files in the allocated storage volume corresponding to one or more of the copies in the cache storage if the at least one criterion of malicious data alteration in the first edge node is met by identifying data alteration corresponding to the generated baits in the cache storage; and
receive the one or more files from the cloud service end and replace the one or more copies in the cache storage with the one or more files from the cloud service end.

82. The storage system of claim 71, wherein at least one of the edge nodes is further configured to calculate file update frequency based on the file update information and updated files corresponding to the at least one of the edge nodes, and wherein the at least one criterion corresponding to the at least one of the edge nodes comprises a threshold of the file update frequency.

83. The storage system of claim 71, wherein if the at least one criterion of malicious data alteration in the first edge node is met:
the first edge node is further configured to transmit data access history associated with the meeting of the criterion of the malicious data alteration therein to the cloud service end; and
the cloud service end is further configured to generate one or more patterns of malicious data alteration, and wherein the identification of the patterns is further configured to be amended to the at least one of criterion of malicious data alteration in at least the second edge node of the edge nodes.

84. The storage system of claim 71, wherein if the at least one criterion of malicious data alteration in the second edge node is met, the cloud service end is further configured to:
generate one or more patterns of malicious data alteration based on data access history associated with the meeting of the criterion of the malicious data alteration in the second edge node; and
transmit the one or more patterns of malicious data alteration to at least the first edge node for the identification of which being amended to the at least one of criterion of malicious data alteration therein.
